(19) United States
(12) Patent Application Publication
(10) Pub. No.: US 2024/0136717 A1
(43) Pub. Date: Apr. 25, 2024

(54) PATCH ANTENNA

(71) Applicant: YOKOWO CO., LTD., Chiyoda-ku, Tokyo (JP)

(72) Inventors: Takashi NOZAKI, Tomioka-Shi, Gunma (JP); Hirotoshi MIZUNO, Tomioka-Shi, Gunma (JP)

(73) Assignee: YOKOWO CO., LTD., Chiyoda-ku, Tokyo (JP)

(21) Appl. No.: 18/277,774

(22) PCT Filed: Feb. 22, 2022
(86) PCT No.: PCT/JP22/07112

§ 371 Date: Aug. 17, 2023

(30) Foreign Application Priority Data
Feb. 24, 2021 (JP) 2021-027893

(51) Int. Cl. H01Q 9/04; H01Q 19/06

(52) U.S. Cl. CPC H01Q 9/0407; H01Q 19/06

(57) ABSTRACT

A patch antenna comprising: a radiating element; a first dielectric member at which the radiating element is provided; and at least one second dielectric member provided around the first dielectric member. A relative dielectric constant of the second dielectric member is larger than a relative dielectric constant of the first dielectric member. The relative dielectric constant of the second dielectric member is 30 or larger.

### TECHNICAL FIELD

The present disclosure relates to a patch antenna.

### BACKGROUND ART

PTL 1 discloses a patch antenna including a ground conductor plate, a dielectric substrate, and a radiating element.

### CITATION LIST

### Patent Literature

[PTL 1] Japanese Patent Application Publication No. 2014-160902

### SUMMARY OF INVENTION

### Technical Problem

When an antenna device housing a patch antenna is reduced in size, the area of a base functioning as a ground for the patch antenna becomes small, which may lower the gain of the patch antenna at low elevation angles.

An example object of the present invention is to improve the gain of a patch antenna at low elevation angles. Other objects of the present invention should become apparent from the descriptions herein.

### Solution to Problem

An aspect of the present disclosure is a patch antenna comprising: a radiating element; a first dielectric member at which the radiating element is provided; and at least one second dielectric member provided around the first dielectric member.

### Advantageous Effects of Invention

According to an aspect of the present invention, the gain of a patch antenna at low elevation angles improves.

### BRIEF DESCRIPTION OF DRAWINGS

FIG. 1 is a side view of a vehicle 1.

FIG. 2 is an exploded perspective view of a vehicular antenna device 10.

FIG. 3 is a perspective view of a patch antenna 30.

FIG. 4 is a sectional view of the patch antenna 30.

FIG. 5 is a plan view of the patch antenna 30 of single-feed type.

FIG. 6 is a plan view of the patch antenna 30 of dual-feed type.

FIG. 7 is a plan view of a patch antenna 30X of a comparative example.

FIG. 8 is a diagram showing the electric field distribution of each of the patch antenna 30X of the comparative example and the patch antenna 30 of the present embodiment.

FIG. 9 is a graph of the relation between the elevation angle and the average gain of the patch antenna 30X of the comparative example.

FIG. 10 is a graph of the relation between the elevation angle and the average gain of the patch antenna 30 (εᵣ₂=20).

FIG. 11 is a graph of the relation between the elevation angle and the average gain of the patch antenna 30 (εᵣ₂=30).

FIG. 12 is a graph of the relation between the elevation angle and the average gain of the patch antenna 30 (εᵣ₂=40).

FIG. 13 is a graph of the relation between the elevation angle and the average gain of the patch antenna 30 (εᵣ₂=2).

FIG. 14 is a graph of the relation between the elevation angle and the average gain of the patch antenna 30 (εᵣ₂=7.82).

FIG. 15 is a graph of the relation between the elevation angle and the average gain of the patch antenna 30 (T=5 mm).

FIG. 16 is a graph of the relation between the elevation angle and the average gain of the patch antenna 30 (T=3 mm).

FIG. 17 is a graph of the relation between the elevation angle and the average gain of the patch antenna 30 (T=7 mm).

FIG. 18 is a graph of the relation between the elevation angle and the average gain of the patch antenna 30 (T=8 mm).

FIG. 19 is a plan view of a patch antenna 30A.

FIG. 20 is a graph of the relation between the elevation angle and the average gain of the patch antenna 30A.

FIG. 21 is a plan view of a patch antenna 30B.

FIG. 22 is a graph of the relation between the elevation angle and the average gain of the patch antenna 30B.

FIG. 23 is a plan view of a patch antenna 30C.

FIG. 24 is a graph of the relation between the elevation angle and the average gain of the patch antenna 30C.

FIG. 25 is a graph of the relation between the elevation angle and the average gain of the patch antenna 30A (W=1 mm).

FIG. 26 is a graph of the relation between the elevation angle and the average gain of the patch antenna 30A (W=4 mm).

FIG. 27 is a graph of the relation between the elevation angle and the average gain of the patch antenna 30A (W=8 mm).

FIG. 28 is a graph of the relation between the elevation angle and the average gain of the patch antenna 30A (W=10 mm).

FIG. 29 is a graph of the relation between the elevation angle and the average gain of the patch antenna 30A (D=15 mm).

FIG. 30 is a graph of the relation between the elevation angle and the average gain of the patch antenna 30A (D=10 mm).

FIG. 31 is a graph of the relation between the elevation angle and the average gain of the patch antenna 30A (D=5 mm).

FIG. 32 is a plan view of a patch antenna 30D.

FIG. 33 is a graph of the relation between the elevation angle and the average gain of the patch antenna 30D.

FIG. 34 is a plan view of a patch antenna 30E.

FIG. 35 is a graph of the relation between the elevation angle and the average gain of the patch antenna 30E.

### DESCRIPTION OF EMBODIMENTS

At least the following points become apparent from the descriptions herein and the drawings attached hereto.

### <<<Attachment Location of a Vehicular Antenna Device 10 for a Vehicle 1>>>

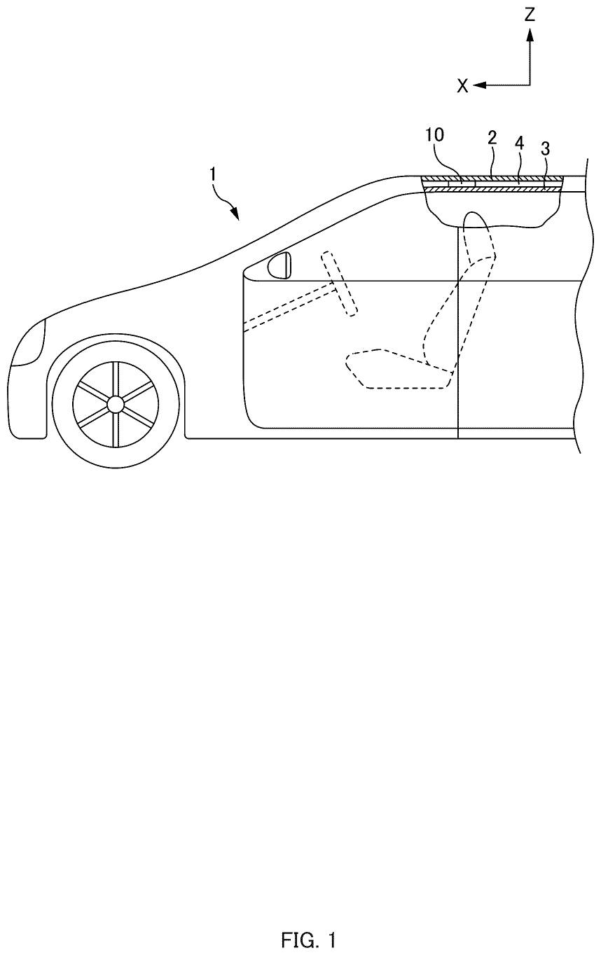

FIG. 1 is a side view of a front part of a vehicle 1 to which a vehicular antenna device 10 is mounted. Hereinafter, a front-rear direction of a vehicle to which the vehicular antenna device 10 is mounted is referred to as an X-direction, a left-right direction perpendicular to the X-direction is referred to as a Y-direction, and a vertical direction perpendicular to the X-direction and the Y-direction is referred to as a Z-direction. Also, as seen from a driver in the vehicle, the front side is referred to as a +X-direction, the right side is referred to as a +Y direction, and the zenith (upward) direction is referred to as a +Z-direction. In the present embodiment described below, the front-rear, left-right, and up-down directions of the vehicular antenna device 10 are the same as the front-rear, left-right, and up-down directions of the vehicle, respectively.

The vehicular antenna device 10 is housed in a void 4 between a roof panel 2 of the vehicle 1 and a roof lining 3 of a ceiling surface of a vehicle interior. The roof panel 2 is formed of, for example, an insulating resin so that the vehicular antenna device 10 can receive electromagnetic waves (hereinafter referred to as “radio waves” where appropriate).

The vehicular antenna device 10 housed in the void 4 is secured to the roof lining 3, which is formed of an insulating resin, with screws or the like. The vehicular antenna device 10 is thus surrounded by the roof panel 2 and the roof lining 3 that are insulating. Although the vehicular antenna device 10 is secured to the roof lining 3 in the present embodiment, the vehicular antenna device 10 may be secured to, for example, a vehicle frame or the resinous roof panel 2.

Also, because the actual void 4 is limited in space, it is difficult to increase the area of a ground plate functioning as a ground for the vehicular antenna device 10. For this reason, when a typical patch antenna is provided in a vehicular antenna device, the gain at low elevation angles may lower. In the present embodiment below, the vehicular antenna device 10 including a patch antenna that can improve its gain at low elevation angles is described.

### <<<Overview of the Vehicular Antenna Device 10>>>

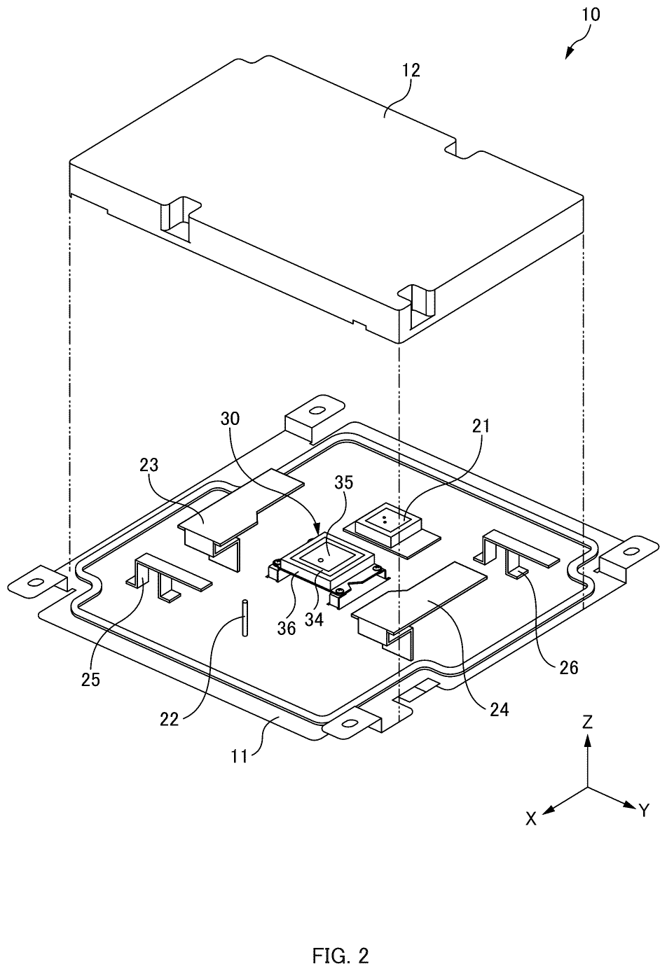

FIG. 2 is an exploded perspective view of the vehicular antenna device 10. The vehicular antenna device 10 is an antenna device including a plurality of antennas with different operating frequency bands and includes a base 11, a case 12, antennas 21 to 26, and a patch antenna 30.

The base 11 is a quadrilateral metal plate used as a common ground by the antennas 21 to 26 and the patch antenna 30 and is placed on the roof lining 3, inside the void 4. Also, the base 11 is a thin plate extending to the front, rear, left, and right.

The case 12 is a box-shaped member, and out of its six faces, the lower face is open. Also, the case 12 is formed of an insulating resin, and for this reason, radio waves may pass through the case 12. Then, the case 12 is attached to the base 11 in such a manner that the opening of the case 12 may be closed by the base 11. Thus, the antennas 21 to 26 and the patch antenna 30 are housed in the internal space of the case 12.

The antennas 21 to 26 and the patch antenna 30 are mounted on the base 11, inside the case 12. The patch antenna 30 is disposed at a position near the center of the base 11, and the antennas 21 to 26 are disposed around the patch antenna 30. Specifically, the antennas 21, 22 are disposed at the front side and the rear side of the patch antenna 30, respectively. Also, the antennas 23, 24 are disposed at the left side and the right side of the patch antenna 30, respectively. Further, the antenna 25 is disposed at the left side of the antenna 22 and the rear side of the antenna 23, and the antenna 26 is disposed at the right side of the antenna 21 and the front side of the antenna 24.

The antenna 21 is, for example, a flat antenna used for the GNSS (Global Navigation Satellite System) and receives radio waves in the 1.5-GHz band from satellites.

The antenna 22 is, for example, a monopole antenna used for the V2X (Vehicle-to-everything) system and transmits and receives radio waves in the 5.8-GHz band or the 5.9-GHz band. Although the antenna 22 is an antenna for V2X here, the antenna 22 may be an antenna for, for example, Wi-Fi or Bluetooth.

The antennas 23, 24 are telematics antennas and are antennas used for, for example, LTE (Long Term Evolution) and the fifth-generation mobile communication system. The antennas 23, 24 transmit and receive radio waves from the 700-MHz frequency band to the 2.7-GHz band defined by the LTE standards. Further, the antennas 23, 24 also transmit and receives radio waves in the Sub-6 band defined by the fifth-generation mobile communication system standards, i.e., radio waves from the 3.6-GHz band to frequencies under 6 GHz.

The antennas 25, 26 are telematics antennas and are antennas used for, for example, the fifth-generation mobile communication system. The antennas 25, 26 transmit and receive radio waves in the Sub-6 band defined by the fifth-generation mobile communication system standards.

The communication standards and frequency bands that can be applied to the antennas 21 to 26 are not limited to the ones described above, and other communication standards and frequency bands may be used.

The patch antenna 30 is an antenna used for, for example, SDARS (Satellite Digital Audio Radio Service). The patch antenna 30 receives left circularly polarized waves in the 2.3-GHz band. SDARS satellites are stationary satellites. For this reason, the patch antenna 30 is required to have favorable gain at low elevation angles as well in order to receive SDARS signals particularly in service areas in Northern Canada (a high latitude region).

### <<<Details of the Patch Antenna 30>>>

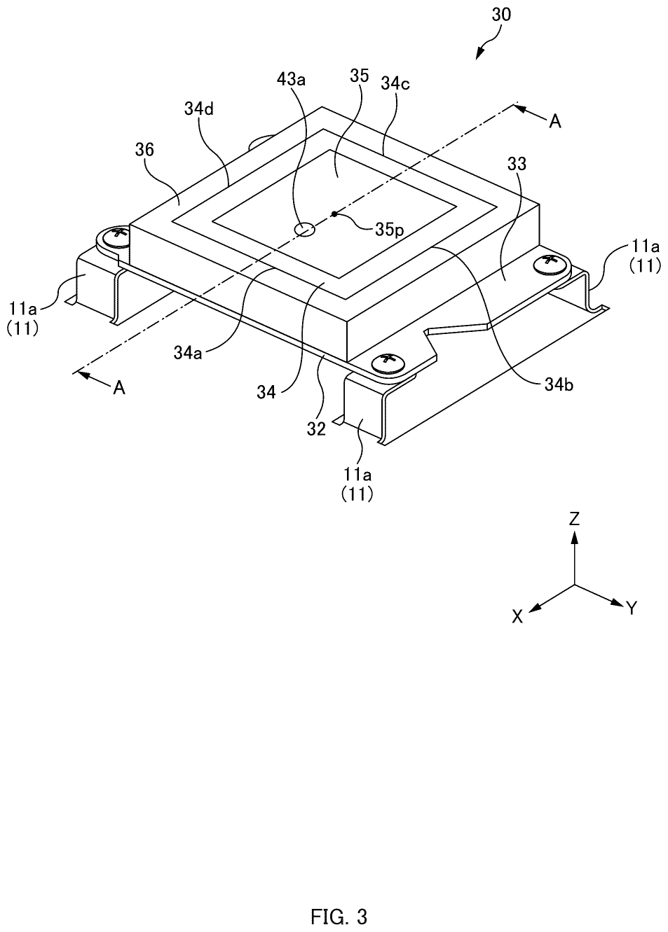

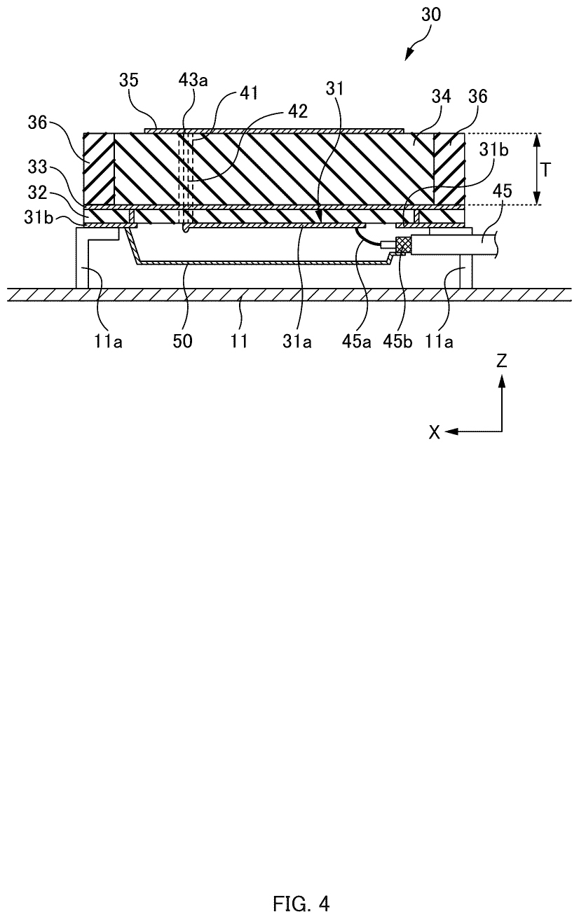

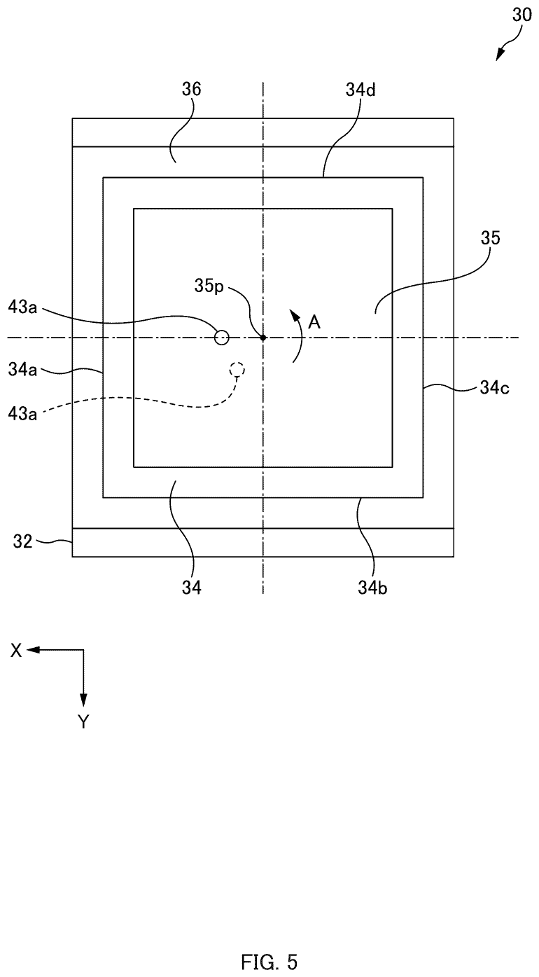

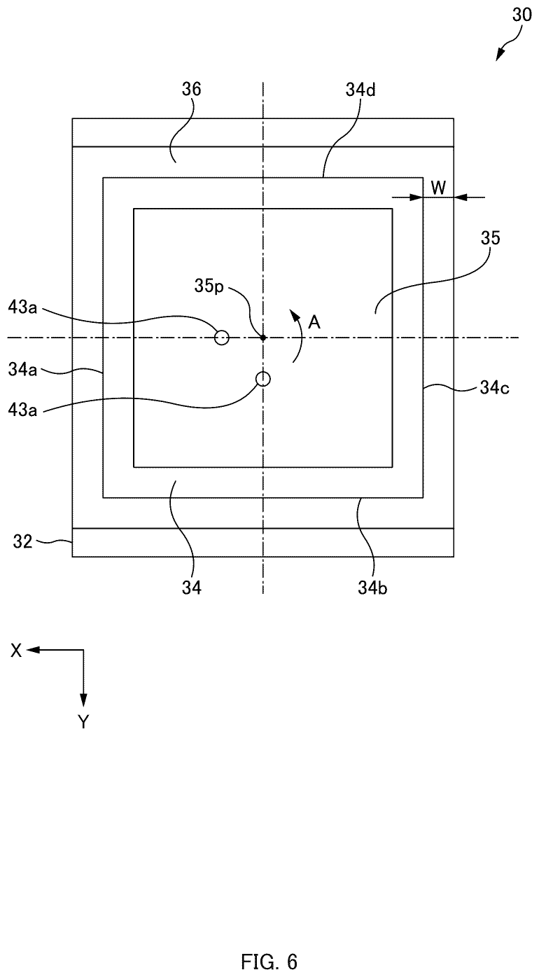

With reference to FIGS. 3 to 6, the patch antenna 30 is described in detail below. FIG. 3 is a perspective view of the patch antenna 30, FIG. 4 is a sectional view of the patch antenna 30 taken along the line A-A in FIG. 3, and FIGS. 5 and 6 are plan views of the patch antenna 30.

The patch antenna 30 is configured including a circuit board 32 on which conductive patterns 31, 33 (to be described later) are formed, a first dielectric member 34, a radiating element 35, a second dielectric member 36, and a shield cover 50. The circuit board 32, the first dielectric member 34 and the second dielectric member 36, and the radiating element 35 stacked in this order in the positive Z-axis direction are hereinafter referred to as a “main body portion of the patch antenna 30” in the present embodiment.

The circuit board 32 is a dielectric plate member having the conductive patterns 31, 33 formed on its back surface (the surface in the negative Z-axis direction) and its front surface (the surface in the positive Z-axis direction), respectively, and is made of, for example, glass epoxy resin. The conductive pattern 31 includes a circuit pattern 31a and a ground pattern 31b.

The circuit pattern 31a is a conductive pattern to which, for example, a signal line 45a of a coaxial cable 45 from an amplifier board (not shown) is connected. Also, a braid 45b of the coaxial cable 45 is electrically connected to a ground pattern 31b with solder (not shown). A description will be given later about the configuration for connecting the circuit pattern 31a and the radiating element 35.

The ground pattern 31b is a conductive pattern for electrically connecting the main body portion of the patch antenna 30 to the metallic base 11. The ground pattern 31b and four seat portions 11a provided at the metallic base 11 are electrically connected to each other. Each of the four seat portions 11a here is formed by bending a part of the base 11 to be able to support the main body portion of the patch antenna 30. By the electrical connecting between the ground pattern 31b and the seat portions 11a, the ground pattern 31b is electrically connected to the metallic base 11. The back surface of the circuit board 32 has, for example, the metallic shield cover 50 attached thereto to protect the circuit pattern 31a.

The conductive pattern 33 formed on the front surface of the circuit board 32 is a ground pattern functioning as a ground for a ground conductor plate (or a ground conductor film) of the patch antenna 30 and a circuit (not shown). The conductive pattern 33 is electrically connected to the ground pattern 31b via a through-hole. Also, the ground pattern 31b is electrically connected to the base 11 via the seat portions 11a and securing screws for securing the circuit board 32 to the seat portions 11a. The conductive pattern 33 is thus electrically connected to the base 11.

The first dielectric member 34 is a substantially quadrilateral plate-shaped member having sides parallel to the X-axis and sides parallel to the Y-axis. The front surface and the back surface of the first dielectric member 34 are parallel to the X-axis and the Y-axis, with the front surface of the first dielectric member 34 facing in the positive Z-axis direction and the back surface of the first dielectric member 34 facing in the negative Z-axis direction. Then, the back surface of the first dielectric member 34 is attached to the conductive pattern 33 with, for example, a double-sided tape. The first dielectric member 34 is formed of a dielectric material such as ceramics. Also, the first dielectric member 34 has sides 34a, 34c parallel to the Y-axis and sides 34b, 34d parallel to the X-axis.

The radiating element 35 is a substantially quadrilateral conductive element having a smaller area than the front surface of the first dielectric member 34 and is formed on the front surface of the first dielectric member 34. In the present embodiment, the direction normal to the radiation surface of the radiating element 35 is the positive Z-axis direction.

A term “substantially quadrilateral” used herein refers to a shape made up of four sides, such as, for example, a square and a rectangle, and for example, at least some of its angles may be cut away obliquely relative to the sides. Also, a “substantially quadrilateral” shape may be provided with a notch (a concave portion) or a protrusion (a convex portion) at part of its sides. In other words, a “substantially quadrilateral shape” may be any shape that allows the radiating element 35 to transmit and receive radio waves of desired frequencies.

The second dielectric member 36 is a dielectric member provided around the first dielectric member 34. As with the first dielectric member 34, the front surface and the back surface of the second dielectric member 36 are parallel to the X-axis and the Y-axis, with the front surface of the second dielectric member 36 facing in the positive Z-axis direction and the back surface of the second dielectric member 36 facing in the negative Z-axis direction. Then, as with the first dielectric member 34, the back surface of the second dielectric member 36 is attached to the conductive pattern 33 with, for example, a double-sided tape.

As shown in FIGS. 3 to 6, in the present embodiment, the second dielectric member 36 is formed in such a shape as to surround an area around the first dielectric member 34. Further, the second dielectric member 36 is in contact with the outer edge (the sides 34a to 34d here) of the first dielectric member 34. Here, the “area around the first dielectric member 34” also includes a range away from the outer edge of the first dielectric member 34. Thus, although the second dielectric member 36 is formed in such manner as to be in contact with the outer edge of the first dielectric member 34 and in such a shape as to surround an area around the first dielectric member 34 in FIGS. 3 to 6, the second dielectric member 36 may be formed in such a manner as to be outwardly away from the outer edge of the first dielectric member 34 and in such a shape as to surround at least part of the area around the first dielectric member 34. Note that outward of the first dielectric member 34 is a direction, on the base 11, away from a center point 35p of the radiating element 35 formed on the first dielectric member 34. Further, the shape of the outer edge of the second dielectric member 36 is substantially quadrilateral. However, as will be described later, the quantity, shape, and installation mode of the second dielectric member 36 are not limited to the ones shown in FIGS. 3 to 6.

Note that the second dielectric member 36 is formed of a dielectric material such as ceramics. The second dielectric member 36 may be formed of the same dielectric material as the first dielectric member 34 or may be formed of a different dielectric material from the first dielectric member 34.

A through-hole 41 penetrates the circuit board 32, the conductive pattern 33, and the first dielectric member 34. Inside the through-hole 41, a feed line 42 connecting the circuit pattern 31a and the radiating element 35 is provided. Note that the feed line 42 connects the circuit pattern 31a to the radiating element 35 while providing electrical insulation from the grounded conductive pattern 33. Also, in the present embodiment, a point where the feed line 42 is electrically connected to the radiating element 35 is referred to as a feed point 43a.

FIG. 5 is a diagram showing the position of the feed point 43a of the radiating element 35 of single-feed type. In the present embodiment, as indicated with the solid line in FIG. 5, the feed point 43a is provided at a position displaced from the center point 35p of the radiating element 35 in the positive X-axis direction. However, the position of the feed point 43a is not limited to this, and for example, as indicated with the broken line in FIG. 5, the feed point 43a may be provided at a position displaced from the center point 35p of the radiating element 35 in the positive X-axis direction and in the negative Y-axis direction.

Note that the “center point 35p of the radiating element 35” refers to the center of the shape of the outer edge of the radiating element 35, i.e., the geometric center thereof. The radiating element 35 of single-feed type in FIG. 5 has, for example, a substantially rectangular shape with different lengths for the longitudinal and lateral sides so as to be able to transmit and receive desired circularly polarized waves. Note that the term “substantially rectangular” refers to a shape encompassed by the term “substantially quadrilateral” described above. Thus, the “center point 35p of the radiating element 35” is a point where diagonal lines of the radiating element 35 intersect.

Although FIGS. 3 to 5 illustrate a configuration where there is only one feed line 42 as a feed line connected to the radiating element 35, two feed lines may be provided by having an additional feed line connected to the radiating element 35. Note that the additional feed line can be provided via a through-hole (not shown) penetrating through the first dielectric member 34 and the like as with the feed line 42, and a description of its detailed configuration is therefore omitted here.

FIG. 6 is a diagram showing the positions of the feed points 43a on the radiating element 35 of dual-feed type. Note that the positions of the two feed points 43a in FIG. 6 are merely an example, and may be any suitable positions that allow the radiating element 35 to transmit and receive desired circularly polarized waves. Also, for example, the radiating element 35 in FIG. 6 has a substantially square shape having equal longitudinal and lateral lengths so as to be able to transmit and receive desired circularly polarized waves. Note that the term “substantially square” refers to a shape encompassed by the term “substantially quadrilateral” described above.

### Comparative Example

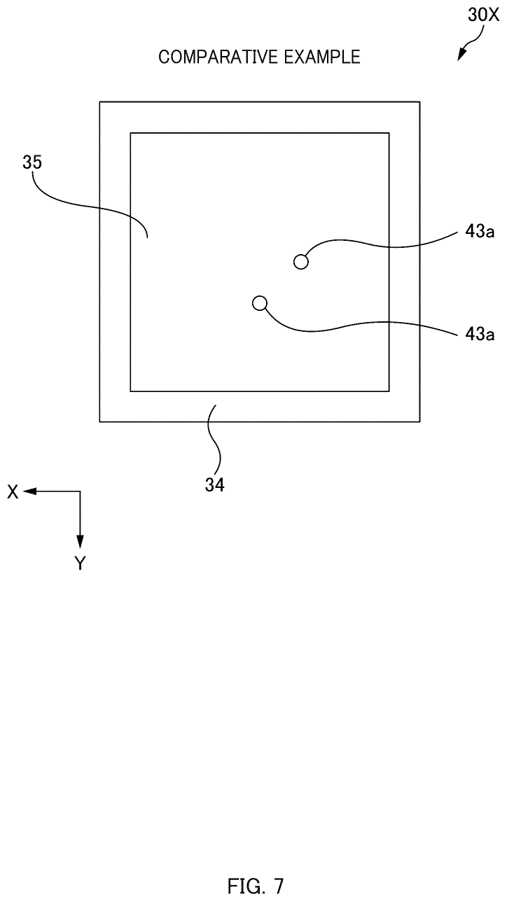

FIG. 7 is a plan view of a patch antenna 30X of a comparative example. The patch antenna 30X is an antenna which is the patch antenna 30 provided with no second dielectric member 36. Note that the patch antenna 30X has the same configuration as the patch antenna 30 of the present embodiment described above, except that the second dielectric member 36 is not provided. For example, the patch antenna 30X is configured including the circuit board 32, the first dielectric member 34, the radiating element 35, and the shield cover 50.

### ==Electric Field Distribution of the Patch Antenna==

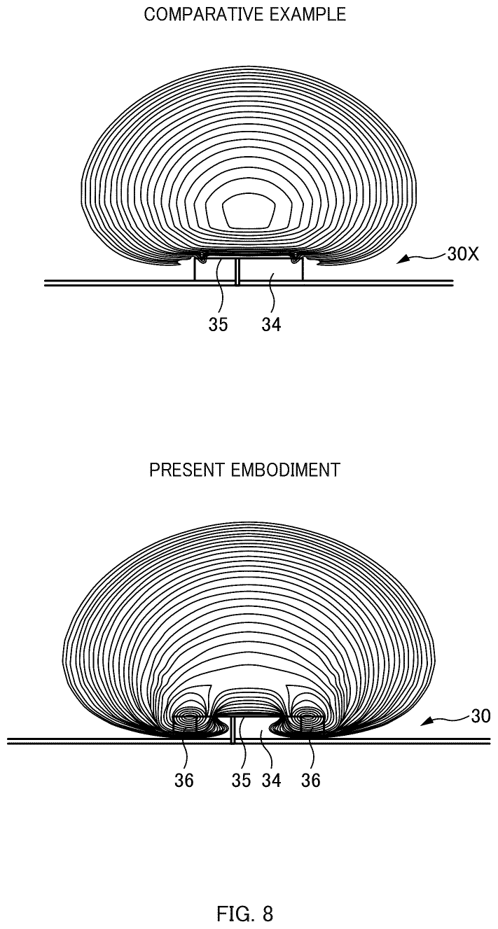

The upper part of FIG. 8 shows a side view of how an electric field distribution is when the patch antenna 30X of the comparative example is used. Also, the lower part of FIG. 8 shows a side view of how an electric field distribution is when the patch antenna 30 of the present embodiment is used. As shown in FIG. 8, in the patch antenna 30X of the comparative example, the electric field spreads substantially only to the upper side of the radiating element 35, whereas in the patch antenna 30 of the present embodiment, the electric field spreads to the lower side of the radiating element 35 as well. This shows that the patch antenna 30 of the present embodiment provides stronger radio wave radiation at low elevation angles than the patch antenna 30X of the comparative example. Thus, by having the second dielectric member 36 provided around the first dielectric member 34, the patch antenna 30 of the present embodiment has a function to provide stronger radio wave radiation at low elevation angles.

### <<<Installation Conditions for the Second Dielectric Member>>>

As described above, the second dielectric member 36 functions to provide stronger radio wave radiation at low elevation angles, and the radiating element 35 receives left circularly polarized waves in the 2.3 GHz band. Thus, the radio waves received by the radiating element 35 are affected by changes in the installation mode and size of the second dielectric member 36. For this reason, first, installation conditions for the second dielectric member 36 are described with reference to FIGS. 4 and 6. Note that in FIG. 6, the direction of the circling of the left circularly polarized waves received by the radiating element 35 is indicated by arrow A.

### ==Relative Dielectric Constant of the Second Dielectric Member=

In the present embodiment, a dielectric material used for the second dielectric member 36 has a relative dielectric constant εᵣ₂ larger than a relative dielectric constant εᵣ₁ of the first dielectric member 34 (εᵣ₂>εᵣ₁). Specifically, a dielectric material with a relative dielectric constant εᵣ₁ of 7.82 is used for the first dielectric member 34, and a dielectric material with a relative dielectric constant εᵣ₂ of is used for the second dielectric member 36. However, as will be described later, a dielectric material used for the second dielectric member 36 may have a relative dielectric constant εᵣ₂ equal to or smaller than the relative dielectric constant εᵣ₁ of the first dielectric member 34 (εᵣ₂≤εᵣ₁).

### ==Width of the Second Dielectric Member==

As shown in FIG. 6, the second dielectric member 36 is provided to surround an area around the first dielectric member 34. In a plan view of the front surface of the radiating element 35 seen in the positive Z-axis direction, the “width W” of the second dielectric member 36 is a dimension of the second dielectric member 36 in a direction orthogonal to the outer edge (here, the sides 34a to 34d) of the first dielectric member 34. In other words, the width W is a distance from an outer edge of the second dielectric member 36 corresponding to an outer edge of the first dielectric member 34 to the outer edge of the first dielectric member 34. Although the width W of the second dielectric member 36 is the same along the entire perimeter in the present embodiment, the present invention is not limited to this. For example, the second dielectric member 36 may have different widths W at positions facing the respective sides of the first dielectric member 34. Also, some of the widths W of the second dielectric member 36 facing the sides of the first dielectric member 34 may be the same. Also, although the sides of the outer edge of the second dielectric member 36 are parallel to the sides of the first dielectric member 34 facing them, the present invention is not limited to this. For example, the second dielectric member 36 may be shaped such that the width W increases or decreases stepwise or gradually.

### ==Thickness of the Second Dielectric Member==

A “thickness T” is, for example, a dimension in the vertical direction (the Z-direction) of a target. For example, in FIG. 4, the dimension of the second dielectric member 36 in the vertical direction (the Z-direction) is the “thickness T” of the second dielectric member 36. In the present embodiment, the second dielectric member 36 is formed such that the thickness T of the second dielectric member 36 may be equal to the thickness T of the first dielectric member 34.

### ==Simulation Conditions 1==

The gain of the patch antenna 30 and the gain of the patch antenna 30X of the comparative example were calculated under predetermined conditions (hereinafter referred to as “simulation conditions 1”), such as the size of the radiating element 35, the relative dielectric constant εᵣ₁ and size of the first dielectric member 34, the relative dielectric constant εᵣ₂ and size of the second dielectric member 36, the size of the base 11, the size of the circuit board 32, and the feed type. For the simulation of the patch antenna 30 and the patch antenna 30X, models without the circuit pattern 31a and the like are used for the sake of convenience because they do not affect the gain much.

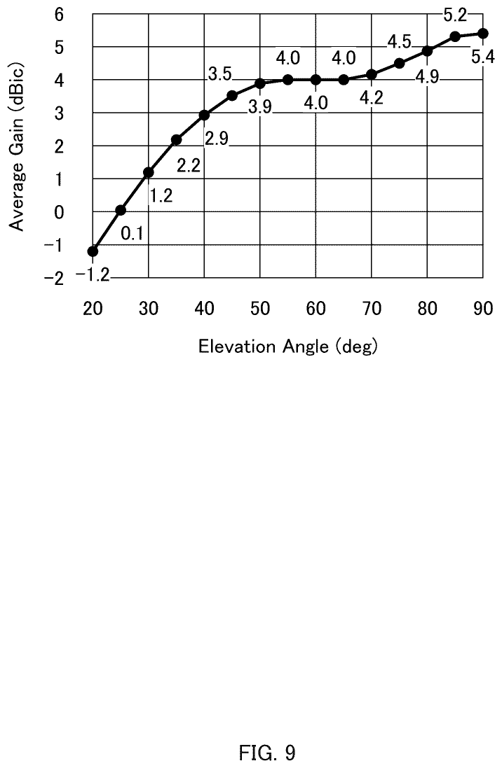

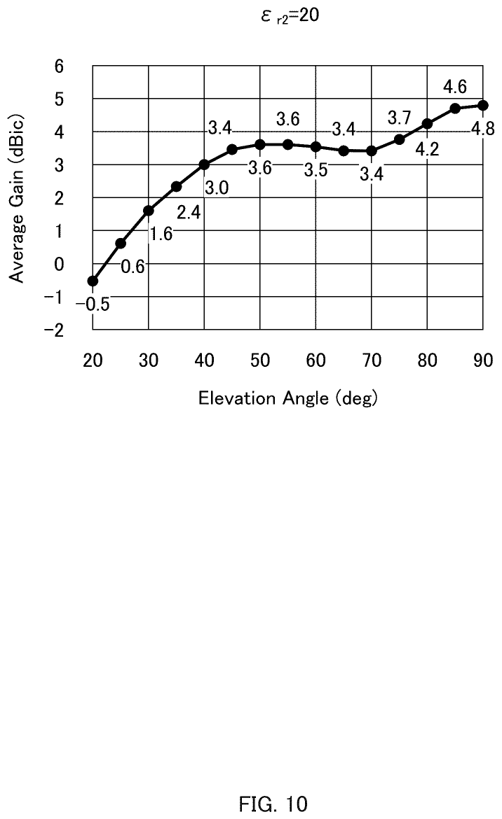

FIG. 9 is a graph showing the relation between the elevation angle and the average gain of the patch antenna 30X of the comparative example. FIG. 10 is a graph showing the relation between the elevation angle and the average gain of the patch antenna 30 of the present embodiment (εᵣ₂=20). In these graphs, the horizontal axis represents the elevation angle, and the vertical axis represents the average gain. As shown in FIG. 9, the patch antenna 30X of the comparative example has average gains of −1.2 dBic, 0.1 dBic, and 1.2 dBic at the elevation angles of 20°, 25°, and 30°, respectively. By contrast, as shown in FIG. 10, the patch antenna 30 of the present embodiment has average gains of −0.5 dBic, 0.6 dBic, and 1.6 dBic at the elevation angles of 20°, 25°, and 30°, respectively. Hence, the patch antenna 30 of the present embodiment has higher average gain at the low elevation angles of 20° to 30° than the patch antenna 30X of the comparative example.

As thus described, when the second dielectric member 36 is provided around the first dielectric member 34, the gain of the patch antenna 30 at low elevation angles improves. As a result, the patch antenna 30 can receive radio waves arriving at low elevation angles efficiently.

### <<<Changing the Installation Conditions for the Second Dielectric Member>>>

Here, a description about changing the installation conditions for the second dielectric member 36 is given. Note that two or more of the conditions described below may be changed and used in combination.

==Changing the Relative Dielectric Constant εᵣ₂==

First, the characteristics that the patch antenna 30 exhibits when the relative dielectric constant εᵣ₂ is changed among the installation conditions for the second dielectric member 36 are examined. Note that the conditions for the patch antenna 30 other than the relative dielectric constant εᵣ₂ (such as, for example, the physical sizes of the main components of the patch antenna 30, the feed type, the relative dielectric constant εᵣ₁ of the first dielectric member 34) and the like are the same as the simulation conditions 1 described earlier.

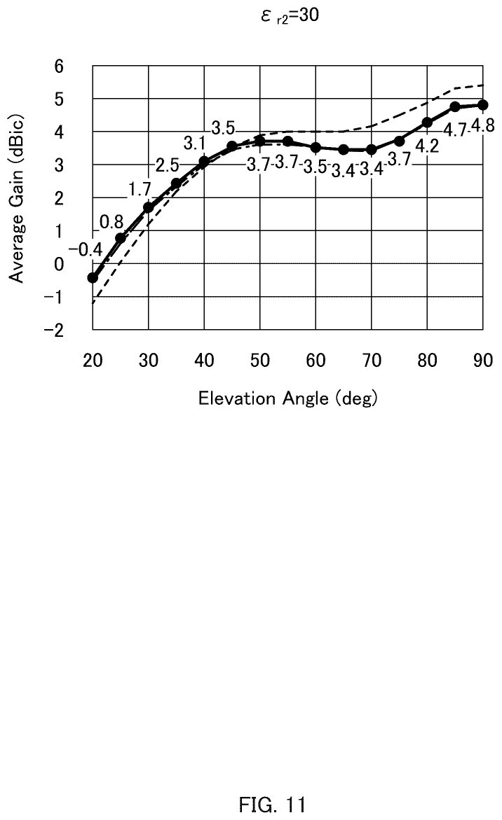

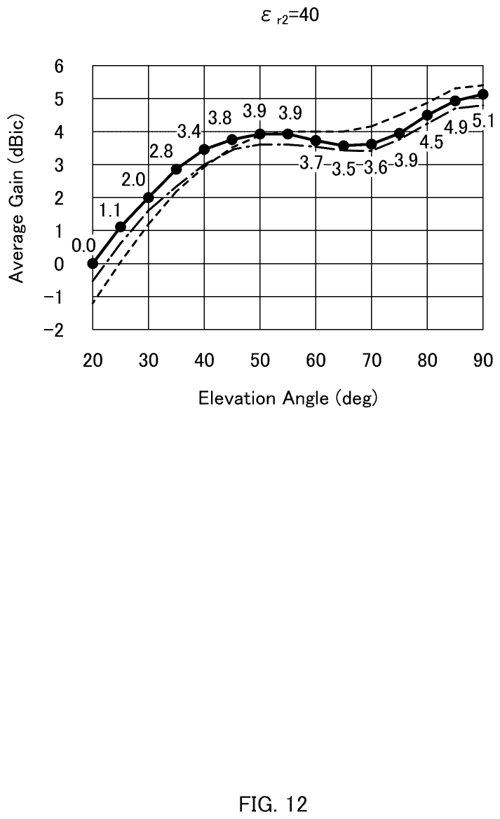

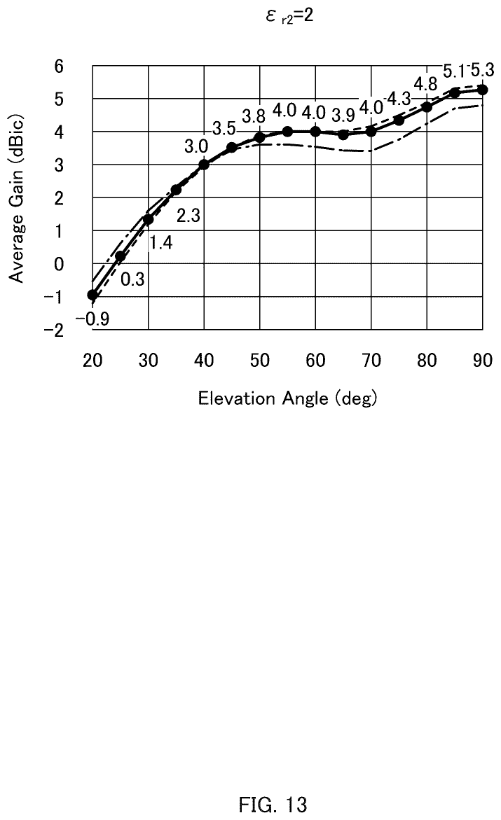

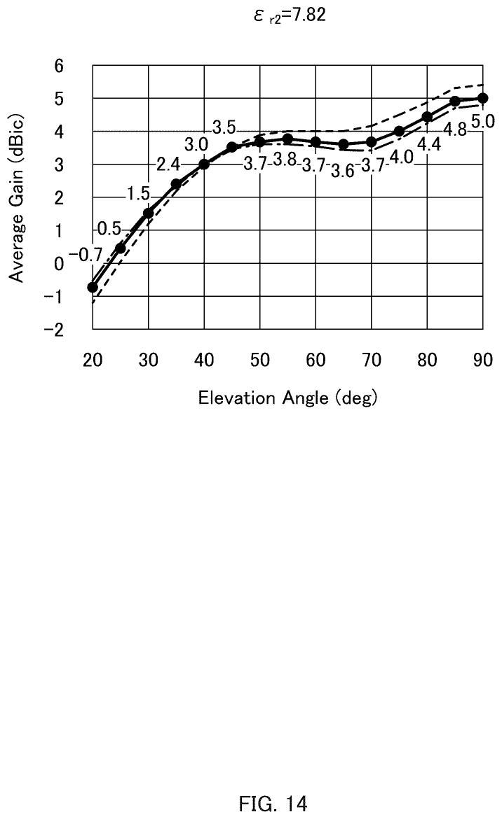

FIGS. 11 to 14 show results of the following modified cases: using the second dielectric member 36 with a relative dielectric constant εᵣ₂ of 30 (εᵣ₂>εᵣ₁), using the second dielectric member 36 with a relative dielectric constant εᵣ₂ of 40 (εᵣ₂>εᵣ₁), using the second dielectric member 36 with a relative dielectric constant εᵣ₂ of 2 (εᵣ₂<εᵣ₁), and using the second dielectric member 36 with a relative dielectric constant εᵣ₂ of 7.82 (εᵣ₂=εᵣ₁). FIG. 11 is a graph showing the relation between the elevation angle and the average gain of the patch antenna 30 (εᵣ₂=30). FIG. 12 is a graph showing the relation between the elevation angle and the average gain of the patch antenna 30 (εᵣ₂=40). FIG. 13 is a graph showing the relation between the elevation angle and the average gain of the patch antenna 30 (εᵣ₂=2). FIG. 14 is a graph showing the relation between the elevation angle and the average gain of the patch antenna 30 (εᵣ₂=7.82). In these graphs, the horizontal axis represents the elevation angle, and the vertical axis represents the average gain. Also, the solid lines indicate the results of these modified cases of the relative dielectric constant εᵣ₂, the dot-dash lines indicate the results obtained by using the second dielectric member 36 of the simulation conditions 1 (the relative dielectric constant εᵣ₂=20) (FIG. 10), and the broken lines indicate results for the patch antenna 30X of the comparative example (FIG. 9).

The patch antenna 30 employing the second dielectric member 36 with a relative dielectric constant εᵣ₂ of 30 has higher average gain at the low elevation angles of 20° to 30° than the patch antenna 30X of the comparative example, as with the case of using the second dielectric member 36 with a relative dielectric constant εᵣ₂ of 20. As shown in FIG. 11, the patch antenna 30 employing the second dielectric member 36 with a relative dielectric constant εᵣ₂ of 30 has average gains of −0.4 dBic, 0.8 dBic, and 1.7 dBic at the elevation angles of 20°, 25°, and 30°, respectively. Further, as shown in FIG. 12, the patch antenna 30 employing the second dielectric member 36 with a relative dielectric constant εᵣ₂ of 40 has average gains of 0.0 dBic, 1.1 dBic, and 2.0 dBic at the elevation angles of 20°, 25°, and 30°, respectively. Hence, the patch antenna 30 employing the second dielectric member 36 with a relative dielectric constant εᵣ₂ of 30 or the second dielectric member 36 with a relative dielectric constant εᵣ₂ of 40 offers higher average-gain improving effect at the low elevation angles of 20° to 30° than the one employing the second dielectric member 36 with a relative dielectric constant εᵣ₂ of 20.

Although cases where the relative dielectric constant εᵣ₂ of the second dielectric member 36 is larger than the relative dielectric constant εᵣ₁ of the first dielectric member 34 (εᵣ₂>εᵣ₁) are examined above, as shown in FIGS. 13 and 14, even when the relative dielectric constant εᵣ₂ of the second dielectric member 36 is equal to or smaller than the relative dielectric constant εᵣ₁ of the first dielectric member 34 (εᵣ₂≤εᵣ₁), average gain at low elevation angles of 20° to 30° is higher than that of the patch antenna 30X of the comparative example. However, the average-gain improving effect is higher when the relative dielectric constant Erg of the second dielectric member 36 is larger than the relative dielectric constant εᵣ₁ of the first dielectric member 34 than when the relative dielectric constant Erg of the second dielectric member 36 is equal to or smaller than the relative dielectric constant εᵣ₁ of the first dielectric member 34. Also, as is apparent from FIGS. 10 to 14, the larger the relative dielectric constant Erg of the second dielectric member 36 is, the higher the average-gain improving effect at low elevation angles is.

Thus, in order for the second dielectric member 36 to contribute to improvement in the gain at low elevation angles, it is preferable that the relative dielectric constant Erg of the second dielectric member 36 be larger than the relative dielectric constant εᵣ₁ of the first dielectric member 34. In this case, the relative dielectric constant Erg of the second dielectric member 36 is preferably 30 or larger or more preferably 35 or larger. Also, it is even more preferable that the relative dielectric constant εᵣ₂ of the second dielectric member 36 be 40 or larger.

### ==Changing the Thickness T of the Second Dielectric Member==

In the patch antenna 30 under the simulation conditions 1, the thickness T of the first dielectric member 34 is 6 mm, and the thickness T of the second dielectric member 36 is also 6 mm. Thus, the thickness T of the first dielectric member 34 is the same as the thickness T of the second dielectric member 36. However, the thickness T of the second dielectric member 36 may be changed.

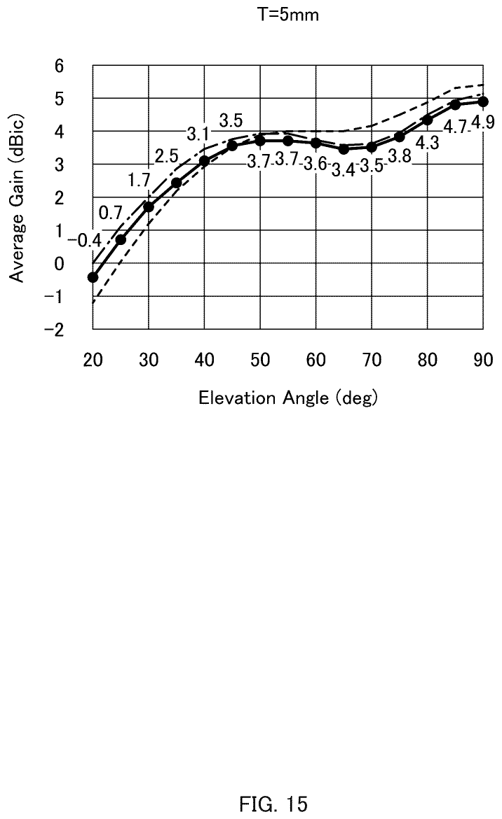

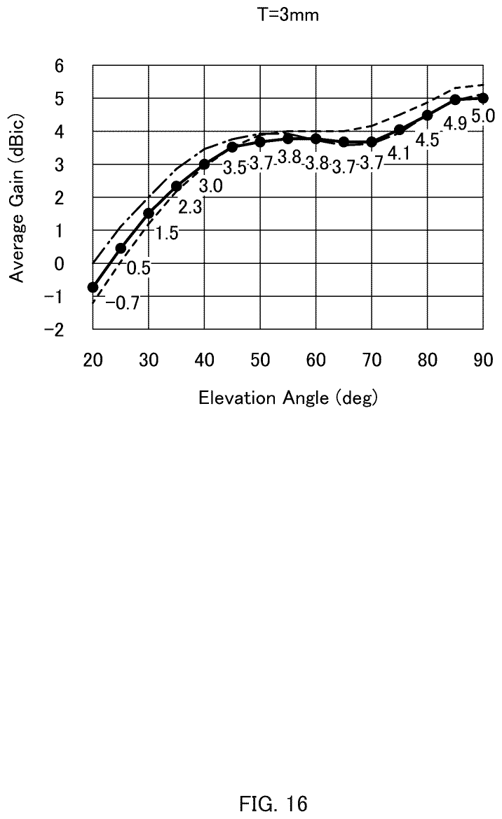

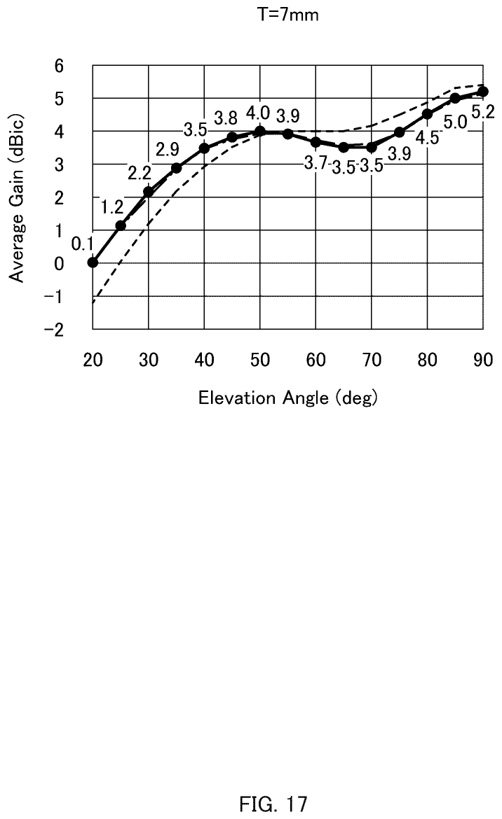

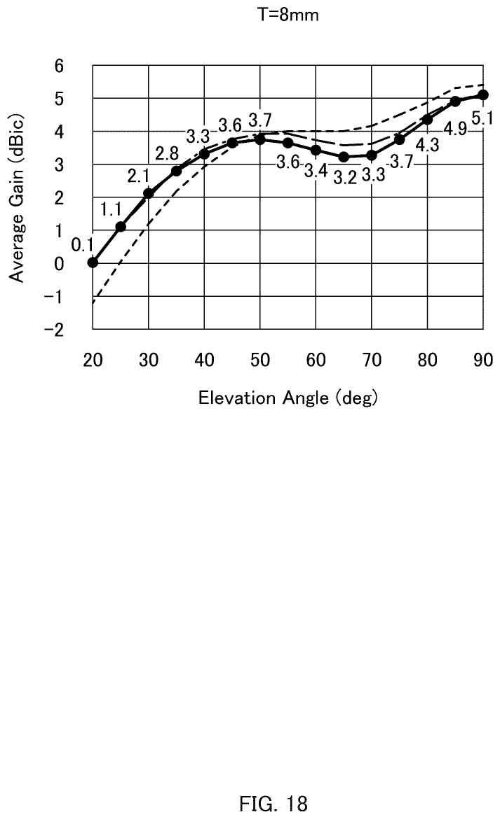

FIGS. 15 and 16 show results obtained by changing the thickness T of the second dielectric member 36 to 5 mm and 3 mm as cases of making the thickness T of the second dielectric member 36 smaller than the thickness T of the first dielectric member 34. Also, FIGS. 17 and 18 show results obtained by changing the thickness T of the second dielectric member 36 to 7 mm and 8 mm as cases of making the thickness T of the second dielectric member 36 larger than the thickness T of the first dielectric member 34. Note that FIGS. 15 to 18 show examination results for patch antennas employing the second dielectric member 36 with a relative dielectric constant εᵣ₂ of 40. Thus, in FIGS. 15 to 18, the solid lines indicate the results of the above cases, the dot-dash lines indicate the results obtained by using the second dielectric member 36 with a thickness T of 6 mm and a relative dielectric constant εᵣ₂ of 40 (FIG. 12), and the broken lines indicate the results for the patch antenna 30X of the comparative example (FIG. 9) for comparison.

As with the patch antenna 30 in which the thickness T of the second dielectric member 36 is set to 6 mm, the patch antenna 30 in which the thickness T of the second dielectric member 36 is set to 5 mm or 3 mm (FIG. 15, 16) has higher average gain at the low elevation angles of 20° to 30° than the patch antenna 30X (FIG. 9). This shows that average gain at the low elevation angles of 20° to 30° is higher than that of the patch antenna 30X even when the thickness T of the second dielectric member 36 is smaller than the thickness T of the first dielectric member 34.

Also, as with the patch antenna 30 in which the thickness T of the second dielectric member 36 is set to 6 mm, the patch antenna 30 in which the thickness T of the second dielectric member 36 is set to 7 mm or 8 mm (FIG. 17, 18) also has higher average gain at the low elevation angles of 20° to 30° than the patch antenna 30X (FIG. 9). This shows that the average gain at the low elevation angles of 20° to 30° is higher than that of the patch antenna 30X even when the thickness T of the second dielectric member 36 is larger than the thickness T of the first dielectric member 34. However, compared to the patch antenna 30 in which the thickness T of the second dielectric member 36 is set to 6 mm (FIG. 12), improvement in the average gain at the low elevation angles of 20° to 30° is not large. Moreover, the larger the thickness T of the second dielectric member 36, the larger the manufacturing costs for the dielectric member and the more difficult it is to reduce the size of the antenna device and the size of the patch antenna.

Thus, in order to reduce the sizes of the antenna device and the patch antenna and further improve the gain at low elevation angles while keeping the manufacturing costs down, it is preferable that the thickness T of the second dielectric member 36 be substantially the same as or smaller than the thickness T of the first dielectric member 34.

### ==Providing a Plurality of Second Dielectric Members 36 Around the First Dielectric Member 34==

Although in the patch antennas 30 examined above, a single second dielectric member 36 is formed in such a shape as to surround the first dielectric member 34, the present invention is not limited to this. A plurality of second dielectric members may be provided around the first dielectric member 34.

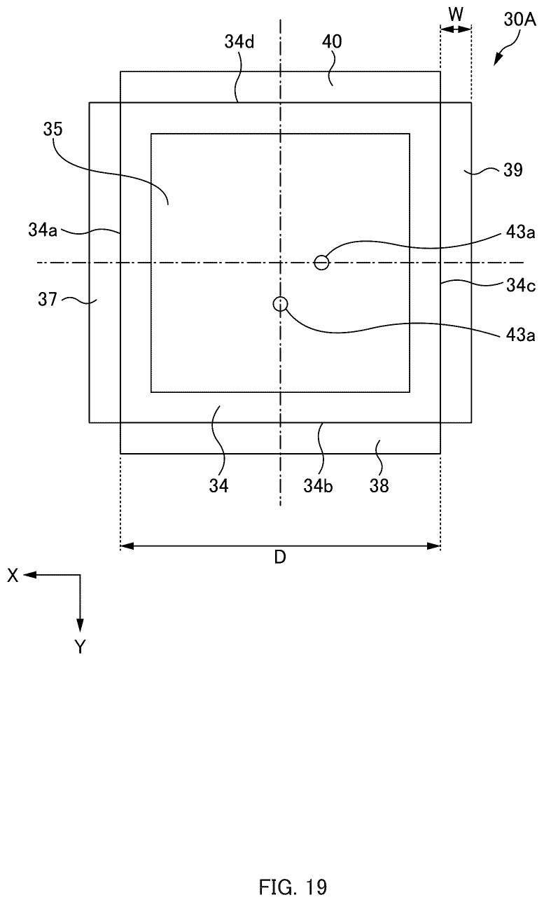

FIG. 19 is a plan view of a patch antenna 30A. As shown in FIG. 19, in the patch antenna 30A, four second dielectric members 37 to 40 are provided around the first dielectric member 34. The radio waves received by the radiating element 35 are affected by changes in the installation mode and size of the second dielectric members 37 to 40. Thus, installation conditions for the second dielectric members 37 to 40 are described with reference to FIG. 19.

### ==Width W of the Second Dielectric Members==

In a plan view of the front surface of the radiating element 35 seen in the positive Z-axis direction, the “width W” of the second dielectric member 39 as an example of the second dielectric members 37 to 40 is, as with the patch antenna 30 shown in FIG. 6, a dimension of the second dielectric member 36 in a direction orthogonal to the outer edge (here, the side 34c) of the first dielectric member 34. In other words, the width W is a distance between an outer edge of the second dielectric member 36 corresponding to an outer edge of the first dielectric member 34 and the outer edge of the first dielectric member 34. The same definition applies to the “width W” of the second dielectric members other than the second dielectric member 39 as well. Although the widths W of the second dielectric members 37 to 40 are all the same in the present embodiment, the present invention is not limited to this. For example, the widths W of the second dielectric members 37 to 40 facing the respective sides of the first dielectric member 34 may be different from one another. Also, some of the widths W of the second dielectric members 37 to 40 facing the sides of the first dielectric member 34 may be the same. Also, although the sides of the outer edge of the second dielectric member 36 are parallel to the sides of the first dielectric member 34 facing them, the present invention is not limited to this. For example, the second dielectric member 36 may be shaped such that the width W increases or decreases stepwise or gradually.

### ==Length D of the Second Dielectric Members==

In a plan view of the front surface of the radiating element 35 seen in the positive Z-axis direction, the “length D” of the second dielectric member 38 as an example of the second dielectric members 37 to 40 is a dimension of the second dielectric member 36 in a direction parallel to the outer edge (here, the side 34b) of the first dielectric member 34. In other words, the length D is a distance between one end portion of the outer edge of the first dielectric member 34 to its closest end portion in linear distance. The same definition applies to the “length D” of the second dielectric members other than the second dielectric member 38 as well. Although the lengths D of the second dielectric members 37 to 40 are all the same in the present embodiment, the present invention is not limited to this. For example, the lengths D of the second dielectric members 37 to 40 facing the respective sides of the first dielectric member 34 may be different from one another. Also, some of the lengths D of the second dielectric members 37 to 40 facing the sides of the first dielectric member 34 may be the same. Also, although the second dielectric members 37 to 40 are substantially in the shape of a quadrangle here, the present invention is not limited to this. For example, the second dielectric members 37 to 40 may be in the shape of a quadrilateral such as a square, a parallelogram, or a trapezoid or in the shape of a triangle.

### ==Gap G to the First Dielectric Member 34==

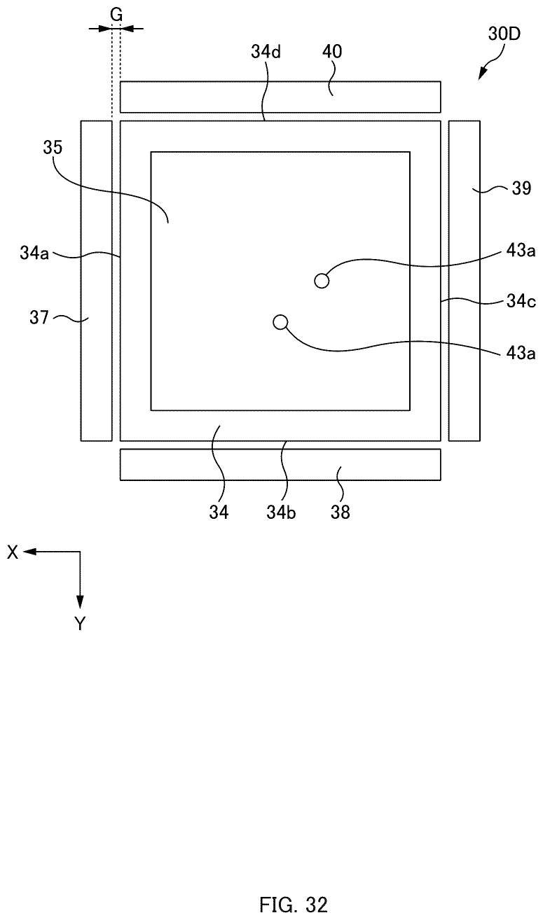

As shown in FIG. 32, in a plan view of the front surface of the radiating element 35 seen in the positive Z-axis direction, a “gap G” between the first dielectric member 34 and the second dielectric member 37 as an example of the second dielectric members 37 to 40 is a distance between a side of the second dielectric member 37 which is closest to the first dielectric member 34 and the outer edge (here, the side 34a) of the first dielectric member 34 which faces the second dielectric member 37. The same definition applies to the “gap G” of the second dielectric members other than the second dielectric member 37 as well. As shown in FIG. 19, the second dielectric members 37 to 40 are in contact with the outer edge (here, the sides 34a to 34d) of the first dielectric member 34. Thus, the gaps G between the first dielectric member 34 and the second dielectric members 37 to 40 are all 0 mm.

### ==Position and Offset Amount OS of the Second Dielectric Members=

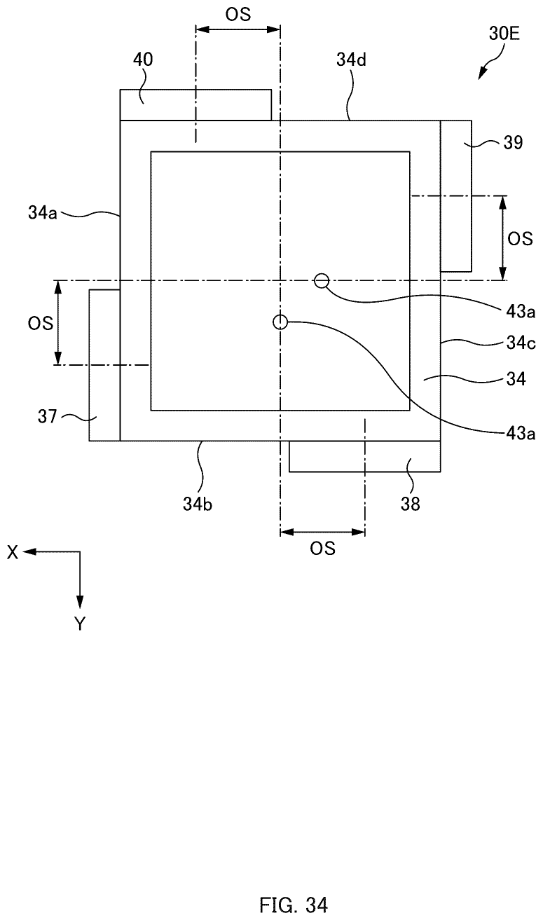

As shown in FIG. 34, a distance by which each of the second dielectric members 38, 40 is displaced in the X-axis direction from the X-axis-direction mid-point of the side 34b (or the side 34d) of the first dielectric member 34 is referred to as an X-axis-direction offset amount OS. Also, a distance by which each of the second dielectric members 37, 39 is displaced in the Y-axis direction from the Y-axis-direction mid-point of the side 34a (or the side 34c) of the first dielectric member 34 is referred to as a Y-axis-direction offset amount OS.

In the example in FIG. 19, the X-axis-direction offset amounts OS of the mid-points of the second dielectric members 38, 40 in the X-axis direction are 0 mm. In other words, the position of the X-axis-direction mid-point of each of the second dielectric members 38, 40 coincides with the X-axis-direction mid-point of the side 34b (or the side 34d) of the first dielectric member 34.

Also, in the example in FIG. 19, the Y-axis-direction offset amounts OS of the mid-points of the second dielectric members 37, 39 in the Y-axis direction are 0 mm. In other words, the position of the Y-axis-direction mid-point of each of the second dielectric members 37, 39 coincides with the Y-axis-direction mid-point of the side 34a (or the side 34c) of the first dielectric member 34.

### ==Disposition of the Second Dielectric Members==

Note that each of the second dielectric members 37 to 40 is provided parallel to the outer edge of the first dielectric member 34. Specifically, the second dielectric member 37 is provided in parallel to the side 34a of the first dielectric member 34, the second dielectric member 38 is provided in parallel to the side 34b of the first dielectric member 34, the second dielectric member 39 is provided in parallel to the side 34c of the first dielectric member 34, and the second dielectric member 40 is provided in parallel to the side 34d of the first dielectric member 34. What is meant by the second dielectric member 40, as an example of the second dielectric members 37 to 40, being “parallel” to the side 34d of the first dielectric member 34 is that the side of the second dielectric member 40 which is closest to the first dielectric member 34 is parallel to the outer edge (here, the side 34d) of the first dielectric member 34 which faces the second dielectric member 40. The same definition applies to how the second dielectric members other than the second dielectric member 40 are parallel to the outer edge of the first dielectric member 34 as well. Also, although the second dielectric members 37 to 40 are substantially in the shape of a quadrangle here, the present invention is not limited to this. For example, the second dielectric members 37 to 40 may be in the shape of a quadrilateral such as a square, a parallelogram, or a trapezoid or in the shape of a triangle.

### ==Simulation Conditions 2==

The gain of the patch antenna 30A and the gain of the patch antenna 30X of the comparative example were calculated below under predetermined conditions (hereinafter referred to as “simulation conditions 2”), such as the width W, the length D, the gap G, and the offset amounts OS of the second dielectric members 37 to 40. Note that various conditions and the like for the patch antenna 30A other than the simulation conditions 2 are the same as the simulation conditions 1 for the patch antenna 30 described earlier.

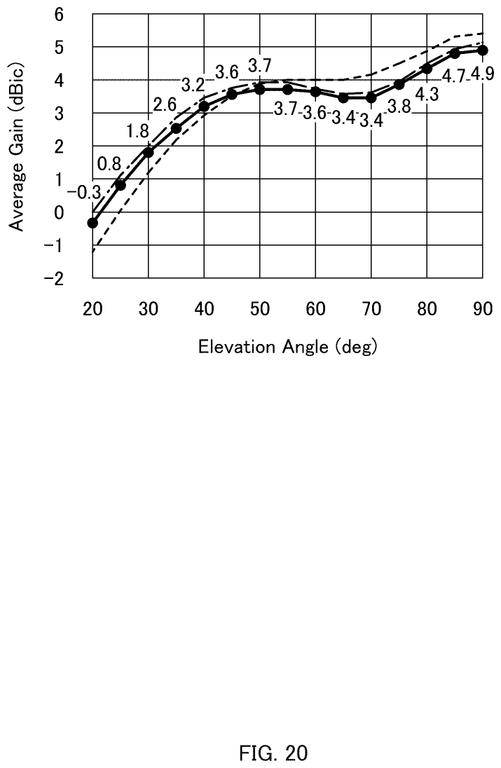

FIG. 20 is a graph of the relation between the elevation angle and the average gain of the patch antenna 30A. In this graph, the horizontal axis represents the elevation angle, and the vertical axis represents the average gain. In FIG. 20, the solid line indicates the results for the patch antenna 30A, the dot-dash line indicates the results for the patch antenna 30 in which the first dielectric member 34 is surrounded by a single second dielectric member 36 (FIG. 12), and the broken line indicates the results for the patch antenna 30X of the comparative example (FIG. 9) for comparison.

As with the patch antenna 30, the patch antenna 30A too has higher average gain at the low elevation angles of 20° to 30° than the patch antenna 30X. This shows that average gain at the low elevation angles of 20° to 30° is higher than that of the patch antenna 30X even when there are four second dielectric members 37 to 40 each being provided in parallel to the outer edge of the first dielectric member 34. As a result, the patch antenna 30A too can efficiently receive radio waves arriving at low elevation angles.

### <<<Changing the Installation Conditions for the Second Dielectric Members>>>

Here, a description about changing the installation conditions for the second dielectric members 37 to 40 is given. Note that two or more of the conditions described below may be changed and used in combination.

### ==Changing the Number of Second Dielectric Members==

In the patch antenna 30A described above, four second dielectric members 37 to 40 are provided around the first dielectric member 34. Alternatively, the number of second dielectric members 37 to 40 provided around the first dielectric member 34 may be changed.

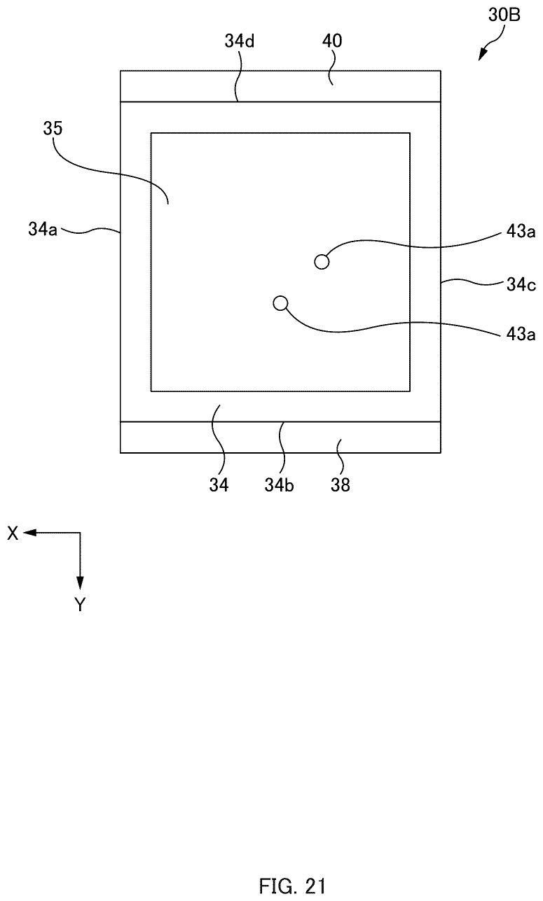

FIG. 21 is a plan view of a patch antenna 30B. The patch antenna 30B is an antenna provided with only two second dielectric members 38, 40, omitting the second dielectric members 37, 39 from the patch antenna 30A shown in FIG. 19. In the patch antenna 30B, each of the second dielectric members 38, 40 is provided in parallel to the outer edge (here, the side 34b or 34d) of the first dielectric member 34.

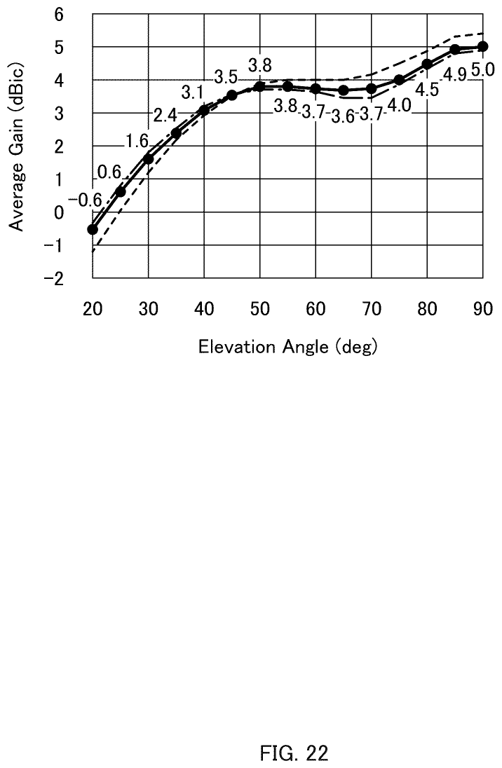

FIG. 22 is a graph of the relation between the elevation angle and the average gain of the patch antenna 30B. In this graph, the horizontal axis represents the elevation angle, and the vertical axis represents the average gain. In FIG. 22, the solid line indicates the results for the patch antenna 30B, the dot-dash line indicates the results for the patch antenna 30A described earlier (FIG. 20), and the broken line indicates the results for the patch antenna 30X of the comparative example (FIG. 9) for comparison.

As with the patch antenna 30A, the patch antenna 30B too has higher average gain at the low elevation angles of 20° to 30° than the patch antenna 30X. This shows that the average gain at the low elevation angles of 20° to 30° is higher than that of the patch antenna 30X not only when there are four second dielectric members 37 to 40, but also when there are two second dielectric members 38, 40 each being provided in parallel to the outer edge of the first dielectric member 34. As a result, the patch antenna 30B too can efficiently receive radio waves arriving at low elevation angles.

Note that the positions at which the two second dielectric members are disposed are not limited to the case shown in FIG. 21. For example, two second dielectric members 37, 39 may be provided in parallel to the side 34a and the side 34c, respectively. Alternatively, two second dielectric members 37, 38 may be provided in parallel to the sides 34a, 34b adjacent to each other. Also, to increase the average gain at the low elevation angles of 20° to 30°, a plurality of second dielectric members 37 to 40 other than the ones described above may be provided around the first dielectric member 34 as well. Also, although the second dielectric members 37 to 40 are substantially in the shape of a quadrangle here, the present invention is not limited to this. For example, the second dielectric members 37 to 40 may be in the shape of a quadrilateral such as a square, a parallelogram, or a trapezoid or in the shape of a triangle.

Note that although the patch antennas 30, 30A, 30B described above receive left circularly polarized waves, they may be ones that receive linearly polarized waves. In such a case, the single feed type is employed, and the feed point 41a is displaced from the center point of the radiating element 35 in the positive X-axis direction. Then, the main polarization plane is a plane defined by a straight line connecting the feed point and the center point of the radiating element 35 and by a line normal to the radiating element 35. Thus, the main polarization plane is parallel to the XZ-plane. Also, the secondary main polarization plane is a plane being orthogonal to the main polarization plane and passing through the center point of the radiating element 35. Thus, the secondary main polarization plane is parallel to the YZ-plane.

The patch antenna 30B may be one that receives linearly polarized waves described above. In that case, the second dielectric members 38, 40 are provided at such positions as to face each other with the radiating element 35 in between in a direction of a straight line connecting the feed point 43a of the radiating element 35 and the center point 35P of the shape of the radiating element 35. Also, when the patch antenna 30B receives linearly polarized waves, the main polarization plane is the XZ-plane, and the second dielectric members 38, 40 intersect with the main polarization plane. Although detailed calculation results are omitted here, the gain at low elevation angles can be improved in this case as well like in FIG. 22.

Although a case where a plurality of second dielectric members 36 are provided around the first dielectric member 34 is examined above, the present invention is not limited to this. A single second dielectric member may be provided at part of an area around the first dielectric member 34.

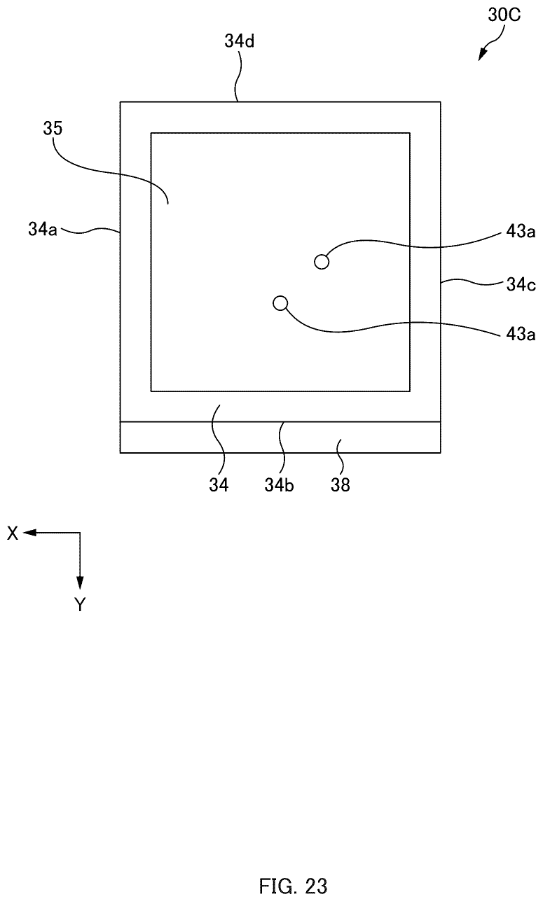

FIG. 23 is a plan view of a patch antenna 30C. The patch antenna 30C is an antenna provided with only the second dielectric member 38, omitting the second dielectric members 37, 39, 40 from the patch antenna 30A shown in FIG. 19. In the patch antenna 30C, the second dielectric member 38 is provided in parallel to the outer edge (here, the side 34b) of the first dielectric member 34.

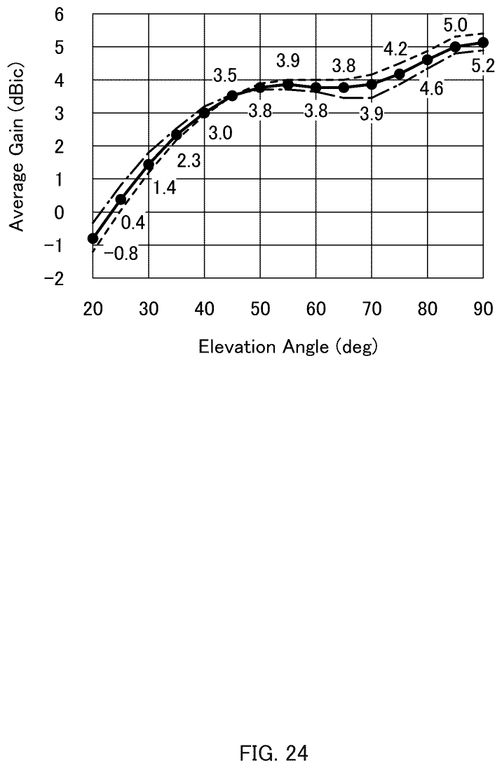

FIG. 24 is a graph of the relation between the elevation angle and the average gain of the patch antenna 30C. In this graph, the horizontal axis represents the elevation angle, and the vertical axis represents the average gain. In FIG. 24, the solid line indicates the results for the patch antenna 30C, the dot-dash line indicates the results for the patch antenna 30A (FIG. 20), and the broken line indicates the results for the patch antenna 30X of the comparative example (FIG. 9) for comparison.

As with the patch antenna 30A, the patch antenna 30C has higher average gain at the low elevation angles of 20° to 30° than the patch antenna 30X. This shows that the average gain at the low elevation angles of 20° to 30° is higher than that of the patch antenna 30X not only when a plurality of second dielectric members 37 to 40 are provided, but also when the single second dielectric member 38 is provided in parallel to the outer edge of the first dielectric member 34.

Note that the disposition and position of the single second dielectric member is not limited to the case shown in FIG. 23. For example, a single second dielectric member 37 may be provided in parallel to the side 34a. Also, although the second dielectric members 37 to 40 are substantially in the shape of a quadrangle here, the present invention is not limited to this. For example, the second dielectric members 37 to 40 may be in the shape of a quadrilateral such as a square, a parallelogram, or a trapezoid or in the shape of a triangle.

### ==Changing the Width W of the Second Dielectric Members==

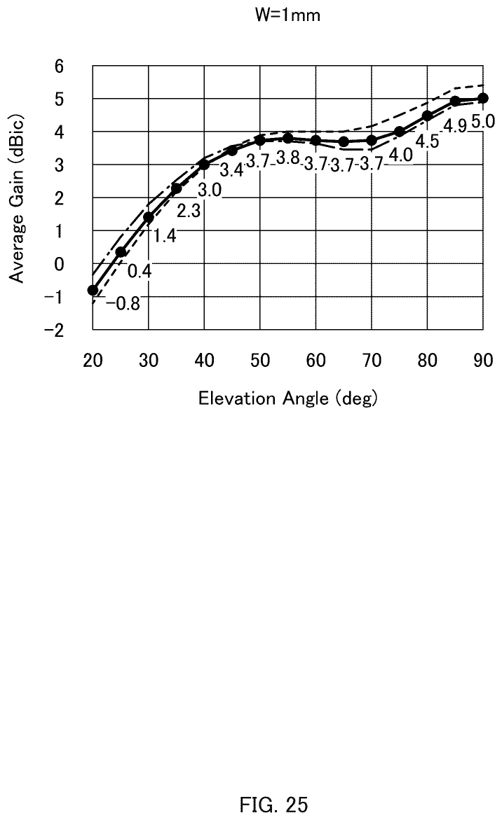

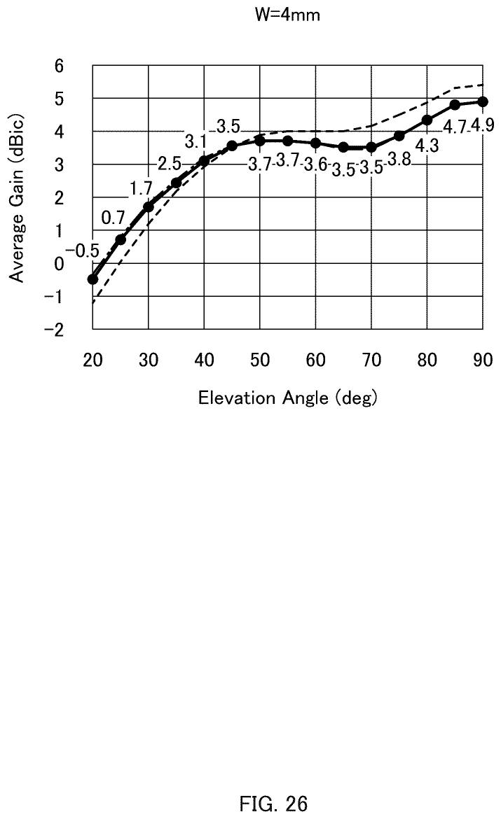

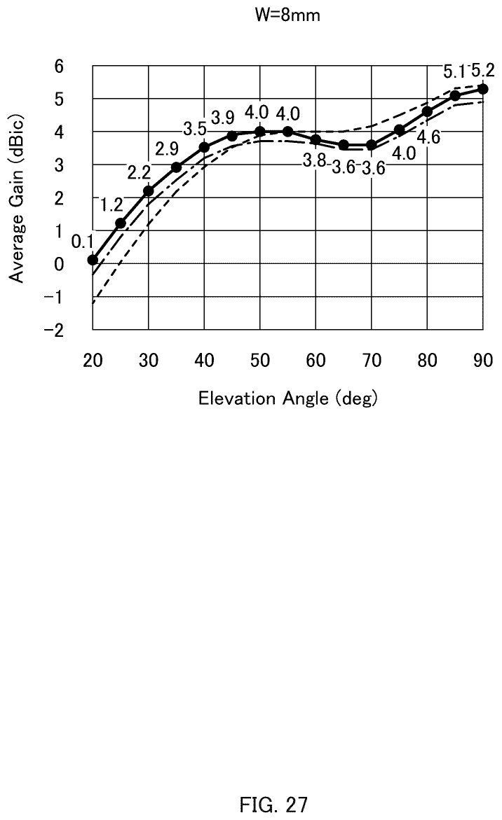

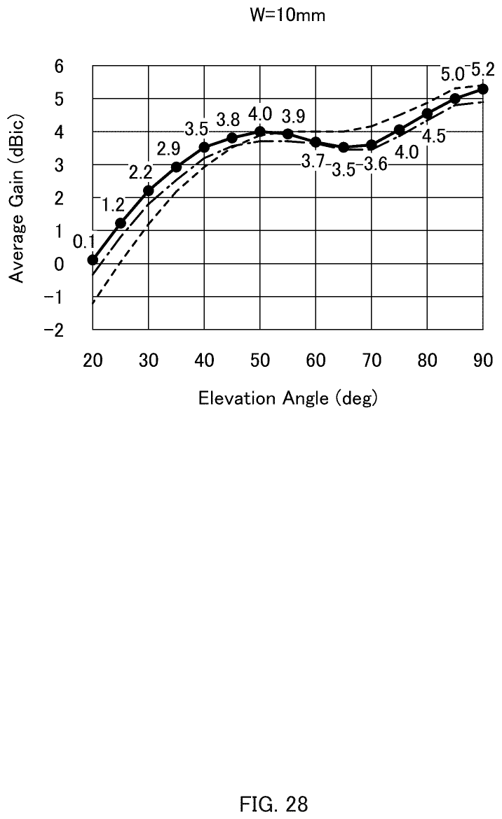

FIGS. 25 to 28 show results from changing the width W in the simulation conditions 2 of the patch antenna 30A to 1 mm, 4 mm, 8 mm, and 10 mm. FIGS. 25 to 28 are graphs showing the relation between the elevation angle and the average gain. In these graphs, the horizontal axis represents the elevation angle, and the vertical axis represents the average gain. In FIGS. 25 to 28, the solid lines indicate the results for these modified cases, the dot-dash lines indicate the results for the patch antenna 30A in which the first dielectric member 34 is surrounded by four second dielectric members 37 to 40 (FIG. 20), and the broken lines indicate the results for the patch antenna 30X (FIG. 9) for comparison.

As with the patch antenna 30 and the patch antenna 30A, average gain at the low elevation angles at 20° to 30° is higher than that of the patch antenna 30X even when the width W is changed. This shows that average gain at the low elevation angles of 20° to 30° is higher than that of the patch antenna 30X even when the width W of each of the second dielectric members 37 to 40 is not 6 mm.

### ==Changing the Length D of the Second Dielectric Members==

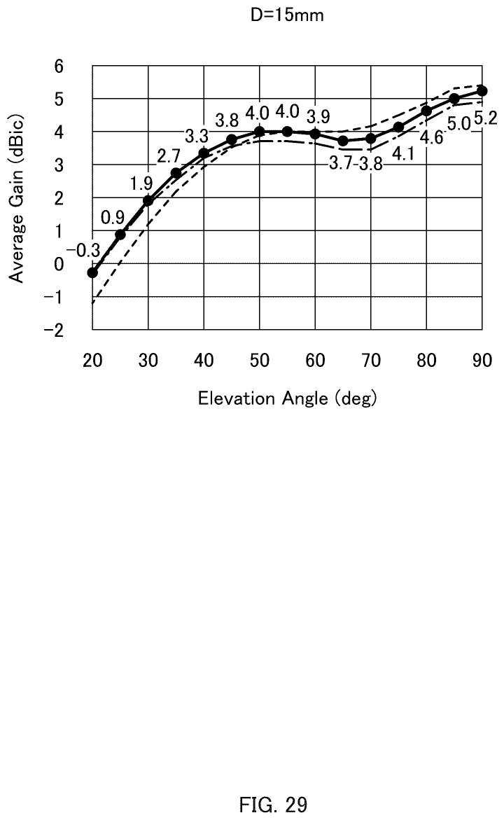

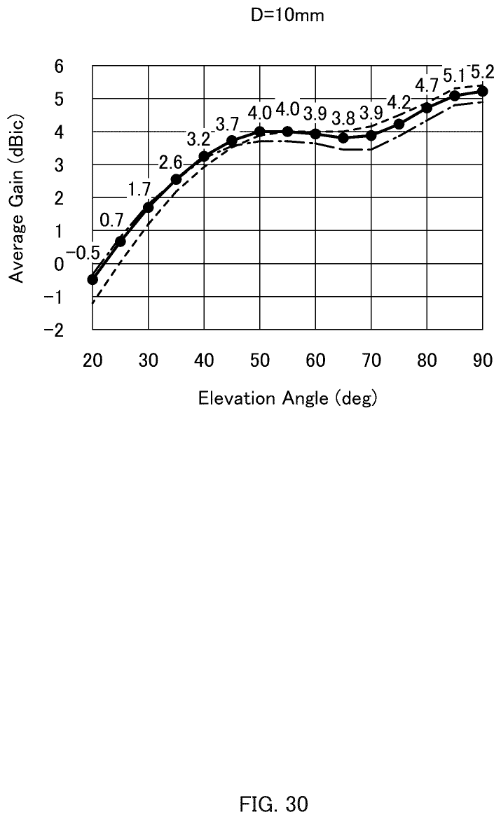

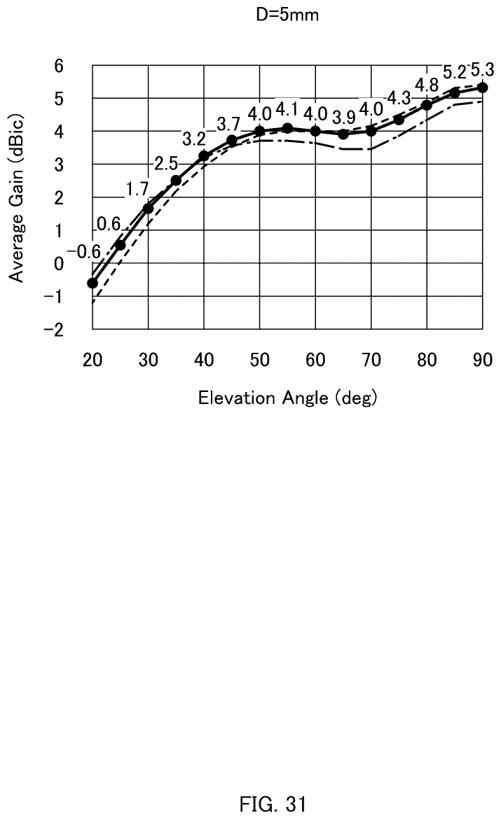

FIGS. 29 to 31 show results from changing the length D in the simulation conditions 2 of the patch antenna 30A to 15 mm, 10 mm, and 5 mm. FIGS. 29 to 31 are graphs showing the relation between the elevation angle and the average gain. In these graphs, the horizontal axis represents the elevation angle, and the vertical axis represents the average gain. In FIGS. 29 to 31, the solid lines indicate the results for these modified cases, the dot-dash lines indicate the results for the patch antenna 30A in which the first dielectric member 34 is surrounded by four second dielectric members 37 to 40 (FIG. 20), and the broken lines indicate the results for the patch antenna 30X (FIG. 9) for comparison.

As with the patch antenna 30 and the patch antenna 30A, average gain at the low elevation angles at 20° to 30° is higher than that of the patch antenna 30X even when the length D is changed. This shows that average gain at the low elevation angles of 20° to 30° is higher than that of the patch antenna 30X even when the length D of each of the second dielectric members 37 to 40 is not 28 mm.

### ==Changing the Gap G==

The second dielectric members 37 to 40 are in contact with the outer edge of the first dielectric member 34 above. Alternatively, the second dielectric members 37 to 40 may be provided outwardly away from the outer edge of the first dielectric member 34.

FIG. 32 is a plan view of a patch antenna 30D. In the patch antenna 30D, four second dielectric members 37 to 40 are provided, and each of the second dielectric members 37 to 40 is provided in parallel to the outer edge (here, the sides 34a to 34d) of the first dielectric member 34. Further, the second dielectric members 37 to 40 are provided outwardly away from the first dielectric member 34. The gap G to the first dielectric member 34 here is 0.5 mm.

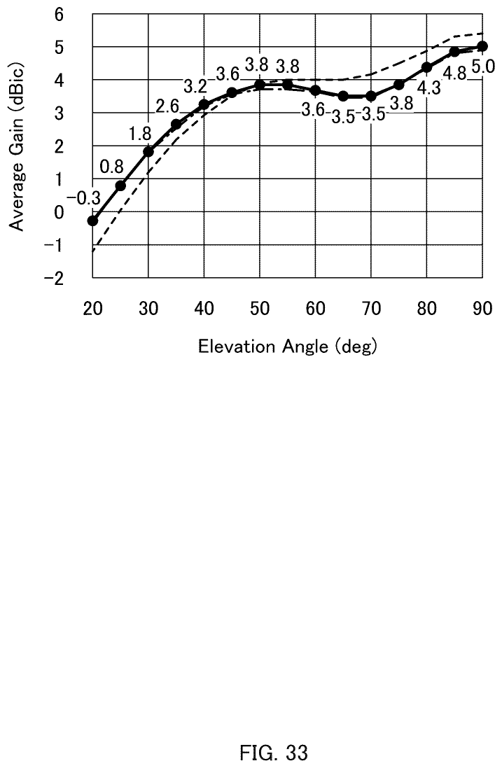

FIG. 33 is a graph of the relation between the elevation angle and the average gain of the patch antenna 30D. In this graph, the horizontal axis represents the elevation angle, and the vertical axis represents the average gain. In FIG. 33, the solid line indicates results for the patch antenna 30D, the dot-dash line indicate the results for the patch antenna 30A (FIG. 20), and the broken line indicates the results for the patch antenna 30X (FIG. 9) for comparison.

As with the patch antenna 30A, the patch antenna 30D too has higher average gain at the low elevation angles of 20° to 30° than the patch antenna 30X. This shows that the average gain at the low elevation angles of 20° to 30° is higher than that of the patch antenna 30X even when the gap G is provided.

Although a case of changing the gap G in the patch antenna 30A in which four second dielectric members 37 to 40 are provided around the first dielectric member 34 is examined above, the present invention is not limited to this. Although detailed calculation results are omitted here, gain at low elevation angles can be improved like in FIG. 33 also in a case where the gap G is changed in the patch antenna 30 (FIG. 6) formed in such a shape that the first dielectric member 34 is surrounded by the single second dielectric member 36. Also, the second dielectric members 37 to 40 may be disposed at an angle to the outer edge of the first dielectric member 34. At least one of the second dielectric members 37 to 40 may be disposed at an angle to the outer edge of the first dielectric member 34. Further, the second dielectric members 37 to 40 may be in the shape of a quadrilateral such as a square, a parallelogram, or a trapezoid or in the shape of a triangle.

### ==Changing the Offset Amounts OS==

Although the X-axis-direction offset amount OS and the Y-axis-direction offset amount OS are both 0 mm in the patch antenna 30A as shown in FIG. 19, they may be changed.

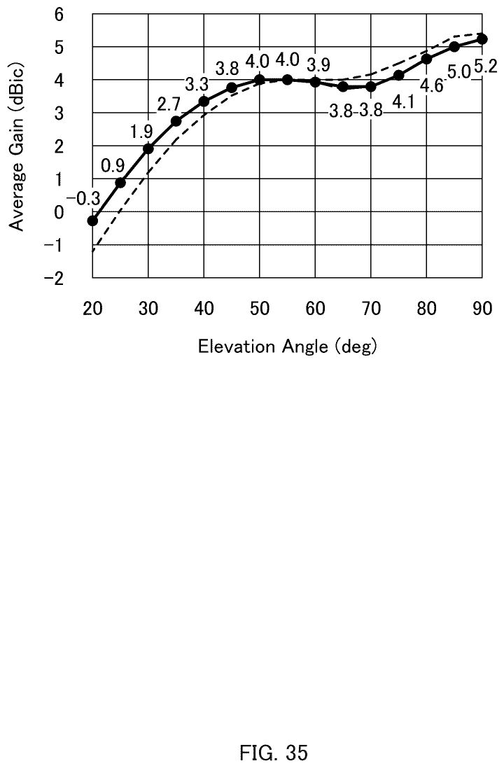

For example, FIG. 34 is a plan view of an example of a patch antenna 30E in which the offset amounts OS are changed. The positions of the X-axis-direction mid-points of the second dielectric members 38, 40 are displaced from the positions of the X-axis-direction mid-points of the sides 34b, 34d of the first dielectric member 34 in the direction of the circling of left circularly polarized waves. Also, the positions of the Y-axis-direction mid-points of the second dielectric members 37, 39 are displaced from the positions of the Y-axis-direction mid-points of the sides 34a, 34c of the first dielectric member 34 in the direction of the circling of left circularly polarized waves. FIG. 35 is a graph showing the relation between the elevation angle and the average gain for a case where the length D is 15 mm and the X-axis-direction and Y-axis-direction offset amounts are 6.5 mm. In this graph, the horizontal axis represents the elevation angle, and the vertical axis represents the average gain. In FIG. 35, the solid line indicates the results for the patch antenna 30E, the dot-dash line indicates the results for the patch antenna 30A without offsets (D=15) (FIG. 29), and the broken line indicates the results for the patch antenna 30X (FIG. 9) for comparison.

As is apparent from FIG. 35, as with the patch antenna 30A without offsets, the patch antenna 30E too can have higher gain at low elevation angles than the patch antenna 30X.

Note that the positions of the X-axis-direction mid-points of the second dielectric members 38, 40 may be displaced from the positions of the X-axis-direction mid-points of the sides 34b, 34d of the first dielectric member 34 in a direction opposite from the direction of circling of left circularly polarized waves. Also, the positions of the Y-axis-direction mid-points of the second dielectric members 37, 39 may be displaced from the positions of the Y-axis-direction mid-points of the sides 34a, 34c of the first dielectric member 34 in a direction opposite from the direction of circling of left circularly polarized waves. Although detailed calculation results are omitted here, the gain at low elevation angles can be improved in this case as well like in FIG. 35. Also, the second dielectric members 37 to 40 may be in the shape of a quadrilateral such as a square, a parallelogram, or a trapezoid or in the shape of a triangle.

While it is possible to improve gain at low elevation angles when the offset amounts OS are set like in, for example, the patch antenna 30E, in this case, the second dielectric members 37 to 40 may protrude outward from the ranges of the sides 34a to 34d of the first dielectric member 34. Consequently, the size of the patch antenna 30E increases in such a configuration. Thus, it is preferable that the offset amounts OS be set so that the second dielectric members 37 to 40 may not be located beyond the ranges of the sides 34a to 34d. Setting the offset amounts OS this way makes it possible to reduce the space for the patch antenna.

### ==Shape of the Radiating Element==

Although the radiating element 35 and the first dielectric member 34 in the patch antenna 30 are “substantially quadrilateral,” the present invention is not limited to this. The radiating element 35 and the first dielectric member 34 may be in the shape of, for example, a circle, an ellipse, or a polygon other than the substantial quadrilateral. In a case where the radiating element 35 or the first dielectric member 34 is, for example, circular, the second dielectric member 36 may be arc-shaped, conforming to the outer edge of the radiating element 35 or the first dielectric member 34. Gain at low elevation angles can be improved also when such a radiating element or second dielectric member is used.

The patch antenna 30 of the present embodiment is provided in the vehicular antenna device 10, but the present invention is not limited to this. For example, the patch antenna 30 may be provided in a casing of a typical shark fin antenna. Also, the patch antenna 30 may be provided in an antenna device mounted to an instrument panel. In this case, the patch antenna 30 may be provided directly to, e.g., a metal plate corresponding to the base 11.

### SUMMARY

The patch antenna 30 of the present embodiment has been described above. For example, as shown in FIGS. 3, 5, 6, 19, 21, 23, 32, and 34, in the patch antennas 30A to 30E, at least one second dielectric member 36 to 40 is provided around the first dielectric member 34, i.e., outward of the outer edge of the first dielectric member 34. For this reason, using such patch antennas 30A to 30E makes it possible to improve gain at low elevation angles. Also, employing such a configuration makes it possible to improve gain at low elevation angles even if the area of the ground is small and not to hinder size reduction of the antenna device and the patch antenna.

In addition, while the relative dielectric constant Erg of the second dielectric member 36 may be equal to or smaller than the relative dielectric constant εᵣ₁ of the first dielectric member 34 (εᵣ₂≤εᵣ₁), it is desirable that the relative dielectric constant εᵣ₂ of the second dielectric member 36 be larger than the relative dielectric constant εᵣ₁ of the first dielectric member 34 (εᵣ₂>εᵣ₁). Providing the second dielectric member 36 having such a relative dielectric constant εᵣ₂ ensures to improve gain at low elevation angles.

In addition, it is desirable that the relative dielectric constant εᵣ₂ of the second dielectric member 36 be 30 or larger (εᵣ₂≥30). Providing the second dielectric member 36 having such a relative dielectric constant εᵣ₂ makes it possible to improve gain at low elevation angles even more.

In addition, it is desirable that the thickness T of the second dielectric member 36 be substantially the same as or smaller than the thickness T of the first dielectric member 34. Providing the second dielectric member 36 having such a thickness T makes it possible to reduce the sizes of the antenna device and the patch antenna while keeping manufacturing costs down.

In addition, as described above, the patch antennas 30A to 30E can improve gain at low elevation angles even in a case where the radiating element 35 receives circularly polarized waves.

In addition, in a case where the radiating element 35 receives circularly polarized waves as described above, in the patch antenna 30, the second dielectric member 36 is formed in such a shape that the first dielectric member 34 is surrounded, as shown in, for example, FIGS. 3, 5, and 6. In this way, gain at low elevation angles can be improved even in a case where the radiating element 35 receives circularly polarized waves.

In addition, in a case where the radiating element 35 receives circularly polarized waves as described above, instead of the second dielectric member 36 being formed in such a shape that the first dielectric member 34 is surrounded, a plurality of second dielectric members 37 to 40 may be provided, with each of the second dielectric members 37 to 40 being provided in parallel to the outer edge of the first dielectric member 34, like, for example, the patch antenna 30A shown in FIG. 19. In this way, gain at low elevation angles can be improved even in a case where the radiating element 35 receives circularly polarized waves.

In addition, the patch antenna 30 can improve gain at low elevation angles in a case of receiving not only circularly polarized waves, but also linearly polarized waves. For example, as shown in FIG. 21, in the patch antenna 30B, a plurality of second dielectric members 38, 40 are disposed at positions facing each other with the radiating element 35 in between and being along the main polarization plane of the radiating element 35. Disposing the second dielectric members 38, 40 at such positions makes it possible to improve the gain at low elevation angles.

Also, for example, the second dielectric members 36 to 40 of the patch antennas 30, 30A, 30B, 30C, 30E shown in FIGS. 3, 5, 6, 19, 21, 23, and 34 are in contact with the outer edge of the first dielectric member 34. Using such patch antennas 30, 30A, 30B, 30C, 30E makes it possible to improve the gain at low elevation angles.

The term “vehicle-mounted” used herein means that the antenna device can be mounted on a vehicle; thus, the antenna device includes not only one which is mounted on a vehicle, but also one which is brought into a vehicle and used inside the vehicle. Also, although the antenna device of the present embodiment is used in a “vehicle” which is a wheeled means of transportation, the present invention is not limited to this, and may be used for, for example, an air vehicle such as a drone, a space probe, wheelless construction machinery, agricultural machinery, a mobile object such as a vessel.

The embodiments described above are provided to facilitate the understanding of the present invention and is not intended to limit the interpretation of the present invention. Also, it goes without saying that the present invention can be modified and improved and that the present invention includes such equivalents as well.

### REFERENCE SIGNS LIST

1 vehicle
2 roof panel
3 roof lining
4 void
10 vehicular antenna device
11 base
11a seat portion
12 case
21 to 26 antenna
30, 30A to 30E patch antenna
31, 33 pattern
31a circuit pattern
31b ground pattern
32 circuit board
34 first dielectric member
34a to 34d side
35 radiating element
35p center point
36 to 40 second dielectric member
41 through-hole
42 feed line
43a feed point
45 coaxial cable
45a signal line
45b braid
50 shield cover

1. A patch antenna comprising:
a radiating element;
a first dielectric member at which the radiating element is provided; and
at least one second dielectric member provided around the first dielectric member.

2. The patch antenna according to claim 1, wherein
a relative dielectric constant of the second dielectric member is larger than a relative dielectric constant of the first dielectric member.

3. The patch antenna according to claim 2, wherein
the relative dielectric constant of the second dielectric member is 30 or larger.

4. The patch antenna according to claim 1, wherein
a thickness of the second dielectric member is substantially same as or smaller than a thickness of the first dielectric member.

5. The patch antenna according to claim 1, wherein
the radiating element is an element that receives a circularly polarized electromagnetic wave.

6. The patch antenna according to claim 5, wherein
the second dielectric member is formed in such a shape as to surround the first dielectric member.

7. The patch antenna according to claim 5, wherein
a plurality of the second dielectric members are provided, and
each of the plurality of second dielectric members is provided in parallel to an outer edge of the first dielectric member.

8. The patch antenna according to claim 1, wherein
the radiating element is an element that receives a linearly polarized electromagnetic wave,
a plurality of the second dielectric members are provided, and
the plurality of second dielectric members are provided at positions facing each other with the radiating element in between in a direction of a straight line connecting a feed point at the radiating element and a center point of a shape of the radiating element.

9. The patch antenna according to claim 1, wherein
the second dielectric member is in contact with an outer edge of the first dielectric member.
